(19) United States
(12) Patent Application Publication
(10) Pub. No.: US 2011/0243249 A1
(43) Pub. Date: Oct. 6, 2011

(54) METHOD AND APPARATUS FOR ENCODING VIDEO BY PERFORMING IN-LOOP FILTERING BASED ON TREE-STRUCTURED DATA UNIT, AND METHOD AND APPARATUS FOR DECODING VIDEO BY PERFORMING THE SAME

(75) Inventors: Tammy LEE, Seoul (KR); Woo-jin HAN, Suwon-si (KR); Byeong-doo CHOI, Siheung-si (KR)

(73) Assignee: SAMSUNG ELECTRONICS CO., LTD., Suwon-si (KR)

(21) Appl. No.: 13/080,209

(22) Filed: Apr. 5, 2011

Related U.S. Application Data
(60) Provisional application No. 61/320,847, filed on Apr. 5, 2010.

(30) Foreign Application Priority Data
Jul. 7, 2010 (KR) 10-2010-0065468

(51) Int. Cl. H04N 7/26

(52) U.S. Cl. 375/240.25; 375/240.01; 375/E07.2; 375/E07.027

(57) ABSTRACT

An apparatus and method of encoding and an apparatus and method of decoding a video by performing in-loop filtering based on coding units are provided. The encoding method includes: splitting a picture into a maximum coding unit; separately determining coding units for outputting encoding results according to a coded depth for deeper coding units that are hierarchically structured according to depths indicating a number of times the coding units are spatially split from the maximum coding unit, wherein the coding units are hierarchical according to the depths in a same region in the maximum coding unit and are independent according to the coded depth in other regions; and determining a filtering unit for performing in-loop filtering so as to minimize an error between the maximum coding unit and an original picture, based on the coding units, and performing in-loop filtering based on the filtering unit.

### CROSS-REFERENCE TO RELATED PATENT APPLICATION

This application claims the benefit of U.S. Provisional Patent Application No. 61/320,847, filed on Apr. 5, 2010, and priority from Korean Patent Application No. 10-2010-0065468, filed on Jul. 7, 2010 in the Korean Intellectual Property Office, the disclosures of which are incorporated herein their entirety by reference.

### BACKGROUND

1. Field

Apparatuses and methods consistent with exemplary embodiments relate to encoding and decoding a video.

2. Description of the Related Art

As hardware for reproducing and storing high resolution or high quality video content is being developed and supplied, there is an increasing need for a video codec for effectively encoding or decoding the high resolution or high quality video content. In a related art video codec, video is encoded according to a limited encoding method based on a macroblock having a predetermined size.

An image restored during video encoding or decoding may locally have defective pixels. A filtering operation with respect to locally defective pixels may deteriorate and a video compression rate due to the defected pixels may be decreased. Thus, the video codec performs loop filtering so as to increase the video compression rate and to improve quality of a restored image by reducing an error between an original image and the restored image.

### SUMMARY

According to an aspect of an exemplary embodiment, there is provided a method of encoding a video by performing in-loop filtering based on coding units, the method including: splitting a picture into a maximum coding unit that is a data unit, wherein the maximum coding unit has a maximum size; separately determining coding units for outputting encoding results according to a coded depth for deeper coding units that are hierarchically structured according to depths indicating a number of times the coding units are spatially split from the maximum coding unit, the coding units according to a tree-structure, wherein the coding units are hierarchical according to the depths in a same region in the maximum coding unit and are independent according to the coded depth in other regions; determining a filtering unit for performing in-loop filtering so as to minimize an error between the maximum coding unit and an original picture, based on the coding units according to the tree-structure of the maximum coding unit; and performing in-loop filtering based on the determined filtering unit.

The determining the filtering unit may include determining the filtering unit based on the coding units according to the tree-structure of the maximum coding unit.

The determining the filtering unit may include determining the filtering unit based on the coding units according to the tree-structure of the maximum coding unit and based on partitions that are data units for prediction encoding of each coding unit according to a coded depth.

The determining the filtering unit may include determining a data unit as the filtering unit, wherein the data unit is obtained by splitting or merging one or more of the coding units according to the tree-structure.

The determining the filtering unit may include using the coding units according to the tree-structure as prediction values of the filtering unit.

The determining the filtering unit may include determining a filtering layer from among layers according to depths of the coding units according to the tree-structure, and determining hierarchical data units up to the filtering layer as the filtering unit.

The filtering layer may be determined as one of layers from an initial layer of each maximum coding unit to a final layer indicating a lowermost depth from among the coding units according to the tree-structure of the maximum coding unit.

With respect to the filtering layer, an upper-limit layer and a lower-limit layer may be set between the initial layer and the final layer.

The method may further include encoding information about the in-loop filtering and transmitting the encoded information about the in-loop filtering, encoded data of the picture, and encoded mode information about the coding units according to the tree-structure of each maximum coding unit, according to the filtering unit.

The information about the in-loop filtering may include at least one of filtering layer information about a filtering layer determined as one of layers of the deeper coding units so as to determine filtering units with respect to the coding units according to the tree-structure, in-loop filtering performance information indicating performance of the in-loop filtering for the filtering units, filter coefficient information for the in-loop filtering, and information about the upper-limit layer and the lower-limit layer of the filtering layer.

The performing the in-loop filtering may include setting the in-loop filtering performance information indicating performance of the in-loop filtering for the filtering unit.

The determining the filtering unit may include separately determining a filtering unit for a luma component of a color component, and a filtering unit for a chroma component of the color component.

The determining the filtering unit may include predicting a filtering unit for a chroma component by referring to a filtering unit for a luma component of a color component.

The determining the filtering unit may include applying a same filtering unit to all of maximum coding units in the current picture.

Filtering units may be separately determined according to one of data units including the picture, a sequence of the picture, a frame, a field, and a maximum coding unit.

The performing the in-loop filtering may include the performing the in-loop filtering by selecting a filter type from among a plurality of filter types.

The performing the in-loop filtering may further include setting in-loop filtering performance information for each of filtering units, wherein the in-loop filtering performance information indicates the performance of the in-loop filtering and indicates the filter type selected from the plurality of filter types.

The in-loop filtering performance information may include a flag for distinguishing a case in which the in-loop filtering using a predetermined filter type is performed from a case in which the in-loop filtering using the predetermined filter type is not performed.

The in-loop filtering performance information may be set so as to distinguish between filter types classified according to predetermined image characteristics of the filtering units or according to coding symbols of the filtering units.

The performing the in-loop filtering may further include generating a filter coefficient so as to perform the in-loop filtering on the filtering units.

The transmitting may include inserting the in-loop filtering information into a Sequence Parameter Set (SPS) or a Picture Parameter Set (PPS) of the picture and transmitting the inserted in-loop filtering information.

According to an aspect of another exemplary embodiment, there is provided a method of decoding a video by performing in-loop filtering based on coding units, the method including: parsing a received bitstream and extracting image data encoded for each of coding units based on the coding units according to a tree-structure which are included in a maximum coding unit obtained by splitting a current picture, extracting encoded mode information about the coding units according to the tree-structure, and extracting information about in-loop filtering of the maximum coding unit; decoding the extracted image data, based on the extracted encoded mode information which is extracted for the maximum coding unit; determining, using the information about in-loop filter, a filtering unit for the in-loop filtering based on the coding units according to the tree-structure of the maximum coding unit; and performing the in-loop filtering on the decoded image data of the maximum coding unit according to the filtering units.

The determining the filtering unit may include determining the filtering unit based on the coding units according to the tree-structure of the maximum coding unit, by referring to the extracted information about in-loop filtering.

The determining the filtering unit may include determining the filtering unit based on the coding units according to the tree-structure of the maximum coding unit and based on partitions that are data units for prediction encoding of each coding unit according to a coded depth, by referring to the information about in-loop filtering.

The determining the filtering unit may include determining a data unit as the filtering unit, wherein the data unit is obtained by splitting or merging one or more of the coding units according to the tree-structure, by referring to the information about in-loop filtering.

The determining the filtering unit may include using the coding units according to the tree-structure as prediction values of the filtering unit, by referring to the information about in-loop filtering.

The determining the filtering unit may include determining hierarchical data units up to the filtering layer as the filtering unit, according to the filtering layer information.

The performing the in-loop filtering may include the determining performance of in-loop filtering for each of the coding units according to the tree-structure of the maximum coding unit, based on the in-loop filtering performance information.

The performing the in-loop filtering may include performing the in-loop filtering by selecting a filter type from among a plurality of filter types, based on the in-loop filtering performance information.

The method may further include performing prediction decoding on a next picture by referring to a current picture to which the in-loop filtering is performed.

According to an aspect of another exemplary embodiment, there is provided a video encoding apparatus for encoding a video by performing in-loop filtering based on coding units, the video encoding apparatus including: an encoding unit determining unit which splits a picture into a maximum coding unit that is a data unit, wherein the maximum coding unit has a maximum size, separately determines coding units for outputting encoding results according to a coded depth for deeper coding units that are hierarchically structured according to depths indicating a number of times the coding units are spatially split from the maximum coding unit, and determines the coding units according to a tree-structure, wherein the coding units are hierarchical according to the depths in a same region in the maximum coding unit and are independent according to the coded depth in other regions; an in-loop filtering unit which determines a filtering unit for performing in-loop filtering so as to minimize an error between the maximum coding unit and an original picture, based on the coding units according to the tree-structure of the maximum coding unit, and performs in-loop filtering based on the filtering unit; and a transmitting unit which encodes information about the in-loop filtering and transmits the encoded information about the in-loop filtering, encoded data of the picture, and encoded mode information about the coding units according to the tree-structure of the maximum coding unit in units of filtering units.

According to an aspect of another exemplary embodiment, there is provided a video decoding apparatus for decoding a video by performing in-loop filtering based on coding units, the video decoding apparatus including: a receiving and extracting unit which parses a received bitstream and extracts image data encoded for each of coding units based on the coding units according to a tree-structure which are included in a maximum coding unit obtained by splitting a current picture, extracts encoded mode information about the coding units according to the tree-structure, and extracts information about in-loop filtering of the maximum coding unit; a decoding unit which decodes the image data encoded for each coding unit, based on the encoded mode information about the coding units according to the tree-structure which is extracted for the maximum coding unit; and an in-loop filtering performing unit which determines, by using the information about in-loop filtering, a filtering unit for in-loop filtering based on the coding units according to the tree-structure of the maximum coding unit, and performs the in-loop filtering on the decoded image data of the maximum coding unit according to the filtering unit.

According to an aspect of another exemplary embodiment, there is provided a computer readable recording medium having recorded thereon a program for executing the method of encoding a video by performing in-loop filtering based on the coding units.

According to an aspect of another exemplary embodiment, there is provided a computer readable recording medium having recorded thereon a program for executing the method of decoding a video by performing in-loop filtering based on the coding units.

### BRIEF DESCRIPTION OF THE DRAWINGS

The above and other features and advantages will become more apparent by describing in detail exemplary embodiments with reference to the attached drawings in which:

FIG. 1 is a block diagram of an apparatus for encoding a video by performing in-loop filtering based on coding units according to a tree-structure, according to an exemplary embodiment;

FIG. 2 is a block diagram of an apparatus for decoding a video by performing in-loop filtering based on coding units according to a tree-structure, according to another exemplary embodiment;

FIG. 3 is a diagram for describing a concept of coding units according to a tree-structure according to an exemplary embodiment;

FIG. 4 is a block diagram of an image encoder based on coding units according to a tree-structure, according to an exemplary embodiment;

FIG. 5 is a block diagram of an image decoder based on coding units, according to a tree-structure according to an exemplary embodiment;

FIG. 6 is a diagram illustrating deeper coding units according to depths, and partitions, according to an exemplary embodiment;

FIG. 7 is a diagram for describing a relationship between a coding unit and transformation units, according to an exemplary embodiment;

FIG. 8 is a diagram for describing encoding information of coding units corresponding to a coded depth, according to an exemplary embodiment;

FIG. 9 is a diagram of deeper coding units according to depths, according to an exemplary embodiment;

FIGS. 10 through 12 are diagrams for describing a relationship between coding units, prediction units, and transformation units, according to an exemplary embodiment;

FIG. 13 is a diagram for describing a relationship between a coding unit, a prediction unit or a partition, and a transformation unit, according to encoding mode information of Table 1;

FIG. 14 is a block diagram of a video encoding and decoding system performing in-loop filtering according to an exemplary embodiment;

FIGS. 15 and 16 illustrate an example of filtering units according to a tree-structure which are included in a maximum coding unit, filtering unit spilt information, and filtering performance information, according to an exemplary embodiment;

FIG. 17 illustrates maximum coding units, and data units including partitions and including coding units according to a tree-structure, which are included in each of the maximum coding units, according to an exemplary embodiment;

FIGS. 18 through 21 respectively illustrate filtering units of filtering layers with respect to the data units of FIG. 17;

FIG. 22 illustrates the filtering units of a filtering layer and in-loop filtering performance information with respect to the data units of FIG. 17;

FIG. 23 is a flowchart of a method of encoding a video by performing in-loop filtering based on coding units according to a tree-structure, according to an exemplary embodiment; and

FIG. 24 is a flowchart of a method of decoding a video by performing in-loop filtering based on coding units according to a tree-structure, according to another exemplary embodiment.

### DETAILED DESCRIPTION OF EXEMPLARY EMBODIMENTS

Hereinafter, exemplary embodiments will be described in detail with reference to the attached drawings.

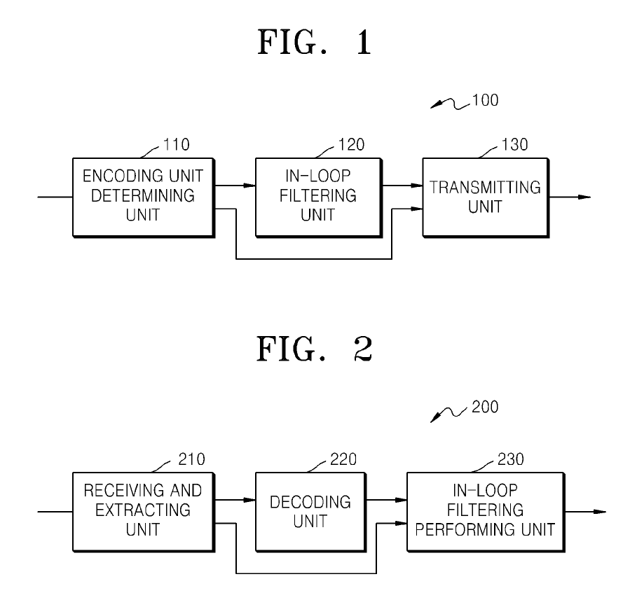

FIG. 1 is a block diagram of an apparatus for encoding a video by performing in-loop filtering based on coding units according to a tree-structure 100, according to an exemplary embodiment.

The apparatus for encoding a video by performing in-loop filtering based on coding units according to a tree-structure 100 (hereinafter, referred to as ‘video encoding apparatus 100’) includes a coding unit determining unit 110, an in-loop filtering unit 120, and a transmitting unit 130.

The coding unit determining unit 110 receives image data of one picture of video and splits the image data by using a maximum coding unit that is a data unit having a maximum size. The maximum coding unit according to an exemplary embodiment may be a data unit having a size of 32×32, 64×64, 128×128, 256×256, etc., wherein a shape of the data unit is a square having a width and a length that are each a multiple of 2 and greater than 8.

For each maximum coding unit, the coding unit determining unit 110 determines coding units according to a tree-structure for each of regions that are spatially split. The coding units of the maximum coding unit are expressed based on a depth indicating a number of times the coding unit is spatially split from the maximum coding unit. The coding units according to the tree-structure include coding units according to a depth determined as a coded depth from among all deeper coding units according to depths which are included in the maximum coding unit. The coding units according to the coded depth may be hierarchically determined according to a depth in the same region in the maximum coding unit and may be independently determined in other regions.

The coding unit determining unit 110 may encode deeper coding units according to depths included in a current maximum coding unit, may compare encoding results with respect to coding units according to an upper depth and a lower depth for each region, and may determine a coding unit and a coded depth corresponding to the coding unit that outputs an optimum encoding result. Also, a coded depth of a current region may be separately determined from a coded depth of another region.

Accordingly, the encoding unit determining unit 110 may determine coding units according to a tree-structure formed of coding units according to coded depths which are separately determined for each region and for each maximum coding unit. Also, the encoding unit determining unit 110 performs prediction coding when the coding unit according to the coded depth is determined. The encoding unit determining unit 110 may determine a prediction unit or a partition, which is a data unit by which the coding unit according to the coded depth performs the prediction coding so as to output the optimum encoding result. For example, a partition type with respect to a coding unit having a size of 2N×2N may include partitions having a size of 2N×2N, 2N×N, N×2N and N×N. A partition type according to an exemplary embodiment may include not only symmetrical partitions obtained by splitting a height or a width of a coding unit according to a symmetrical ratio but also selectively include partitions split according to an asymmetrical ratio of 1:n or n:1, partitions that are geometrically split, partitions having random shapes, or the like. A prediction mode of the partition type may include an inter mode, an intra mode, a skip mode and the like.

A coding unit according to an exemplary embodiment may be characterized by a maximum size and a depth. The depth denotes a number of times the coding unit is hierarchically split from the maximum coding unit, and as the depth deepens, deeper coding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit deepens, a coding unit corresponding to an upper depth may include a plurality of coding units corresponding to lower depths.

The uppermost depth denotes a number of times a coding unit of image data is split from the maximum coding unit to the minimum coding unit. Also, the uppermost depth may denote a total number of splitting times from the maximum coding unit to the minimum coding unit. For example, when a depth of the maximum coding unit is 0, a depth of coding units obtained by splitting the maximum coding unit once may be set as 1, and a depth of coding units obtained by splitting the maximum coding unit twice may be set as 2. In this case, if a minimum coding unit denotes coding units obtained by splitting the maximum coding unit four times, a depth level includes a depth of 0, 1, 2, 3, and 4, and a maximum depth may be set as 4.

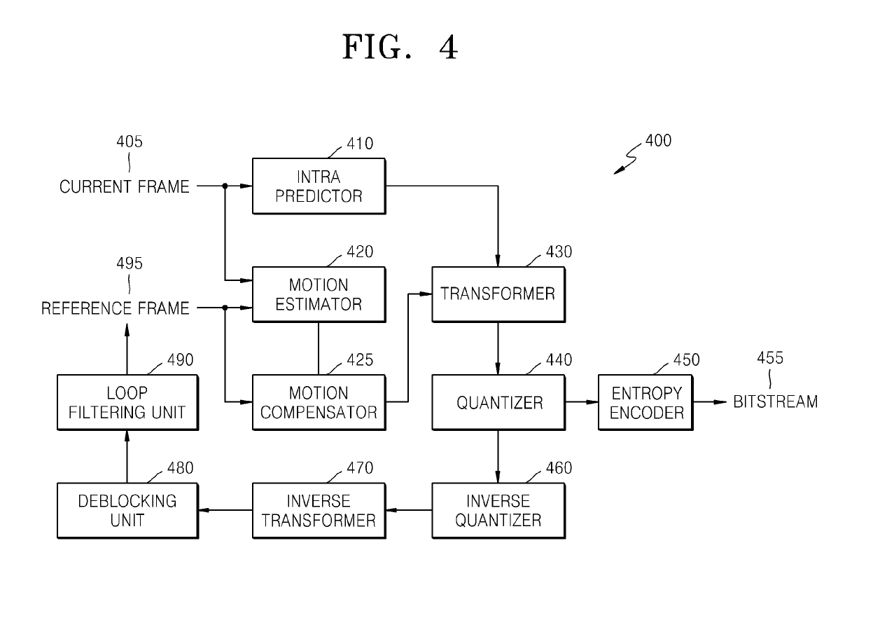

A method of determining coding units and partitions according to a tree-structure of the maximum coding unit, according to exemplary embodiments, will be described in detail with reference to FIGS. 3 through 13.

The in-loop filtering unit 120 determines a filtering unit for performing in-loop filtering, based on the coding units according to the tree-structure of the maximum coding unit which are determined by the encoding unit determining unit 110, and performs the in-loop filtering according to the filtering unit.

The in-loop filtering unit 120 may determine the filtering unit based on the coding units and partitions according to the tree-structure of the maximum coding unit. For example, the filtering unit may be determined by splitting or merging one or more data units of the coding units and partitions according to the tree-structure. Also, the filtering unit may be predicted in a manner that the coding units and partitions according to the tree-structure are used as prediction values for the filtering unit.

The in-loop filtering unit 120 according to an exemplary embodiment may determine a filtering layer from among layers according to depths of the coding unit among the coding units according to the tree-structure of the maximum coding unit, and may determine hierarchical coding units and partitions according to the filtering layer as a filtering unit.

The in-loop filtering unit 120 according to another exemplary embodiment may determine a filtering layer by including partition layers and the layers according to depths of the coding unit, and may determine hierarchical coding units and partitions up to the filtering layer as a filtering unit. Thus, a filtering layer according to an exemplary embodiment may be one of layers from an initial layer of the maximum coding unit to a final layer indicating a minimum coding unit or a prediction unit from among the coding units according to the tree-structure of the maximum coding unit.

Also, an upper-limit layer and a lower-limit layer may be set between the initial layer and the final layer, so that the filtering layer may be determined between the upper-limit layer and the lower-limit layer.

With respect to every filtering unit, the in-loop filtering unit 120 may set in-loop filtering performance information indicating performance of in-loop filtering, information about the initial layer and the final layer of the filtering layer, and information about the upper-limit layer and the lower-limit layer.

The in-loop filtering unit 120 may separately perform in-loop filtering on a luma component of a color component, and in-loop filtering on a chroma component. Thus, the in-loop filtering unit 120 may separately determine a filtering unit for the luma component, and a filtering unit for the chroma component. Also, the in-loop filtering unit 120 may predict the filtering unit for the chroma component by referring to the filtering unit for the luma component.

The in-loop filtering unit 120 may apply the same filtering unit to all maximum coding units in a picture. The in-loop filtering unit 120 may apply the same filtering unit to a current frame.

However, the in-loop filtering unit 120 may apply different filtering units to maximum coding units in a picture. For example, the filtering unit may be determined according to one of data units including a sequence, a picture, a frame, a field, and a maximum coding unit, so that the same filtering unit may be applied to the same data unit.

The in-loop filtering unit 120 may set the in-loop filtering performance information indicating performance of in-loop filtering, with respect to each filtering unit. Also, the in-loop filtering unit 120 may perform the in-loop filtering by selecting one of a plurality of filter types. Accordingly, for each determined filtering unit, the in-loop filtering unit 120 may set in-loop filtering performance information indicating both performance of in-loop filtering and a filter type selected from the plurality of filter types.

The in-loop filtering performance information may be a flag for distinguishing a case in which in-loop filtering using a predetermined filter type is performed from a case in which in-loop filtering using the predetermined filter type is not performed. Also, the in-loop filtering performance information may be set so as to distinguish between filter types that are used in the in-loop filtering and are classified according to a predetermined characteristic. In addition, the in-loop filtering performance information may be set so as to distinguish between filter types that are classified according to coding symbols.

The in-loop filtering is performed to minimize an error between a predicted picture and an original picture. Thus, the in-loop filtering unit 120 may use an adaptive filter so as to minimize an error between a maximum coding unit of the predicted picture and a corresponding region of the original picture. Accordingly, the in-loop filtering unit 120 may generate a filter coefficient in a filtering unit so as to perform the in-loop filtering, and may set filter coefficient information.

The transmitting unit 130 may encode in-loop filtering information determined by the in-loop filtering unit 120 and may transmit the in-loop filtering information together with encoded data of a picture and encoding mode information about the coding units according to the tree-structure of the maximum coding unit. The transmitting unit 130 transmits the in-loop filtering information, the encoded data, and the encoding mode information about the coding units by a unit of a filtering unit.

The in-loop filtering information may include filtering layer information about the coding units according to the tree-structure, the in-loop filtering performance information indicating performance of in-loop filtering for each filtering unit, the filter coefficient information for in-loop filtering, and the information about the upper-limit layer and the lower-limit layer of the filtering layer.

The transmitting unit 130 may insert the in-loop filtering information into a Sequence Parameter Set (SPS) or a Picture Parameter Set (PPS) of a picture and then may transmit the in-loop filtering information.

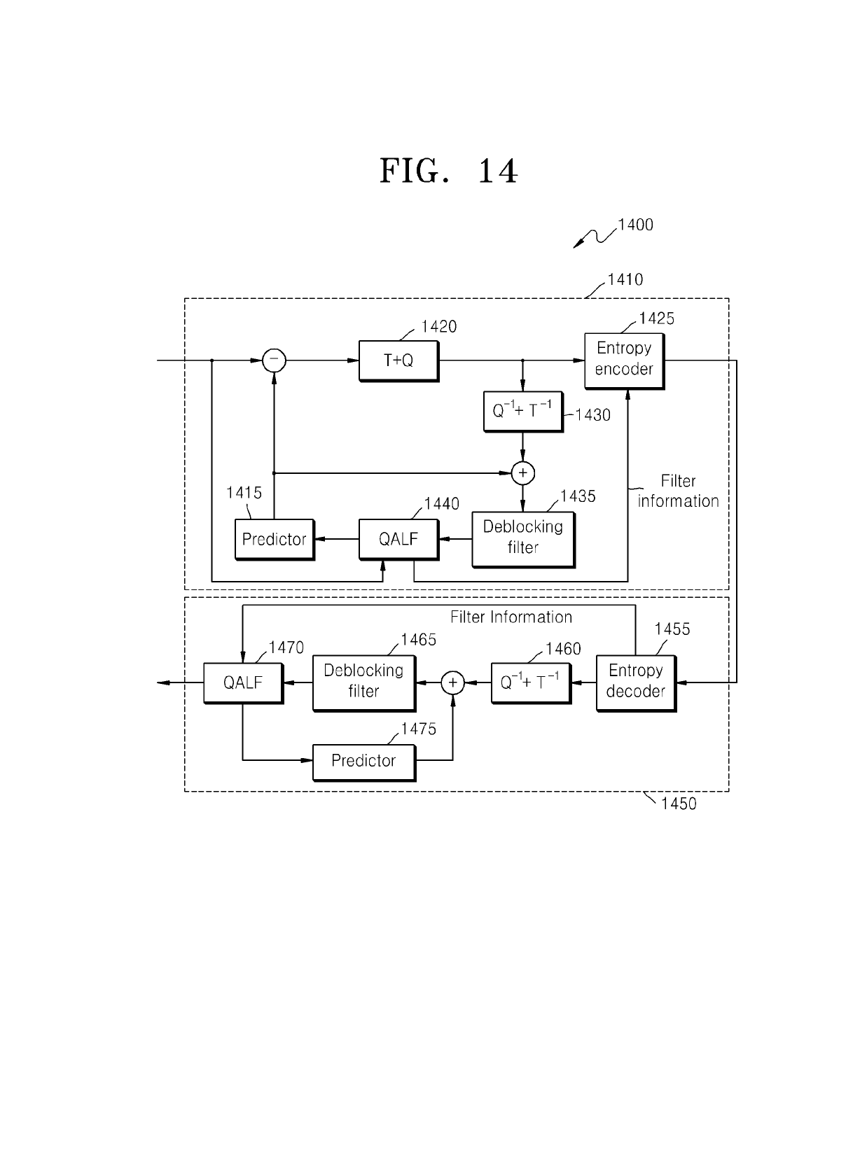

The determination of the filtering unit for the in-loop filtering and encoding of the in-loop filtering performance information according to exemplary embodiments will be described in detail with reference to FIGS. 14 through 24.

The encoding unit determining unit 110 may determine coding units having an optimum shape and an optimum size for each of maximum coding units, based on the size of the maximum coding unit and the maximum depth determined considering characteristics of the current picture. Also, since encoding may be performed on each maximum coding unit by using any one of various prediction modes and transformations, an optimum encoding mode may be determined considering characteristics of the coding unit of various image sizes.

Thus, if an image having a high resolution or large data amount is encoded in a related art macroblock having a fixed size of 16×16 or 8×8, a number of macroblocks per picture excessively increases. Accordingly, a number of pieces of compressed information generated for each macroblock increases, and thus it is difficult to transmit the compressed information and data compression efficiency decreases. However, by using the encoding unit determining unit 110, image compression efficiency may be increased since a coding unit is adjusted while considering characteristics of an image while increasing a maximum size of a coding unit while considering the size of the image.

Also, by performing the in-loop filtering based on the coding units according to the tree-structure, a reference picture having undergone the in-loop filtering is used, so that the prediction encoding may be performed while reducing the error between the predicted picture and the original picture. Also, the in-loop filtering unit 120 determines the filtering unit for the in-loop filtering, based on the determined coding units, so that a bit amount used to transmit additional information for the in-loop filtering may be decreased.

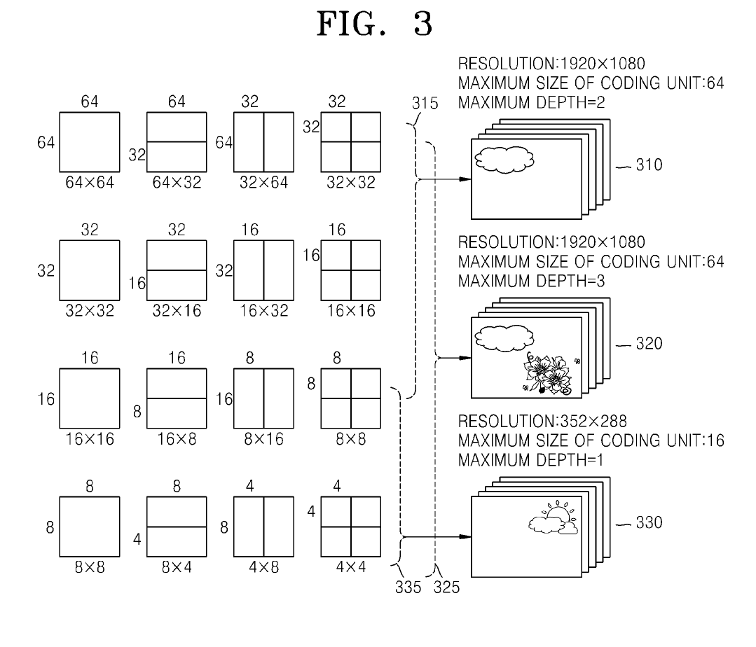

FIG. 2 is a block diagram of an apparatus for decoding a video by performing in-loop filtering based on coding units according to a tree-structure 200 according to another exemplary embodiment.

The apparatus for decoding a video by performing in-loop filtering based on coding units according to a tree-structure 200 (hereinafter, referred to as ‘video decoding apparatus 200’) includes a receiving and extracting unit 210, a decoding unit 220, and an in-loop filtering performing unit 230.

The receiving and extracting unit 210 receives and parses a bitstream of an encoded video, and extracts encoded image data, encoding mode information about coding units, and in-loop filtering information for each of the coding units according to the tree-structure and for each of maximum coding units. The receiving and extracting unit 210 may extract the in-loop filtering information, the encoded image data, and the encoding mode information from the parsed bitstream, wherein the extraction is performed by a unit of a filtering unit. The receiving and extracting unit 210 may also extract the in-loop filtering information from a SPS or a PPS of a picture.

The decoding unit 220 decodes the encoded image data for each of the decoding units, based on the encoding mode information about the coding units according to the tree-structure, which is extracted by the receiving and extracting unit 210.

The decoding unit 220 may read coding units according to a coded depth and partition types, prediction modes, transformation modes and the like of the coding units included in a maximum coding unit, based on the encoding mode information about the coding units according to the tree-structure of the maximum coding unit.

The decoding unit 220 may decode the encoded image data based on the partition type, the prediction mode, and the transformation mode, which are read from each of the coding units according to the tree-structure of the maximum coding unit, so that the decoding unit 220 may decode the encoded image data of the maximum coding unit.

The image data decoded by the decoding unit 220, and the in-loop filtering information extracted by the receiving and extracting unit 210 are input to the in-loop filtering performing unit 230.

The in-loop filtering performing unit 230 determines a filtering unit for in-loop filtering based on the coding units according to the tree-structure of the maximum coding unit, by using the in-loop filtering information. For example, the in-loop filtering performing unit 230 may determine the filtering unit by splitting or merging one or more coding units of the coding units according to the tree-structure, based on the in-loop filtering information. In another example, the in-loop filtering performing unit 230 may predict a filtering unit for a current maximum coding unit by using the coding units according to the tree-structure as prediction values, based on the in-loop filtering information. Also, the in-loop filtering performing unit 230 may determine whether to perform in-loop filtering on the decoded image data by using the in-loop filtering information, based on the filtering unit of the maximum coding unit.

The filtering performing unit 230 according to another exemplary embodiment may determine a filtering unit for in-loop filtering based on the coding units and partitions according to the tree-structure of the maximum coding unit, by using the in-loop filtering information.

In more detail about the in-loop filtering information, the receiving and extracting unit 210 may extract filtering layer information, in-loop filtering performance information, filter coefficient information, and information about an upper-limit layer and a lower-limit layer of a filtering layer, and may transmit the extracted information to the in-loop filtering performing unit 230.

The in-loop filtering performing unit 230 may determine a coding unit to the filtering layer as the filtering unit, wherein the coding unit is from among the coding units according to the tree-structure. Also, the in-loop filtering performing unit 230 may determine whether to perform in-loop filtering on each of the coding units according to the tree-structure of the maximum coding unit, based on the in-loop filtering performance information.

The in-loop filtering performing unit 230 may separately determine a filtering unit for a luma component and a filtering unit for a chroma component according to the filtering layer information, and may separately perform in-loop filtering on each of the luma component and the chroma component. Also, the in-loop filtering performing unit 230 may predict the filtering unit for the chroma component by referring to the filtering unit for the luma component, according to the filtering layer information, and may separately perform in-loop filtering on each of the luma component and the chroma component.

The in-loop filtering performing unit 230 may apply the same filtering unit to maximum coding units in a picture, or may apply the same filtering unit to a current frame.

The in-loop filtering performing unit 230 may determine the filtering unit according to one of data units including a current sequence, a picture, a frame, a field, and a maximum coding unit.

The in-loop filtering performing unit 230 may perform the in-loop filtering by selecting one of a plurality of filter types based on the in-loop filtering performance information. Also, the in-loop filtering performing unit 230 may determine whether to perform the in-loop filtering on each filtering unit, based on the in-loop filtering performance information, and if it is determined to perform the in-loop filtering, the in-loop filtering performing unit 230 may further determine a filter type from the plurality of filter types.

The in-loop filtering performance information may be a flag for distinguishing a case in which in-loop filtering using a predetermined filter type is performed from a case in which in-loop filtering using the predetermined filter type is not performed. Thus, the in-loop filtering performing unit 230 may determine whether to perform the in-loop filtering on each filtering unit.

The in-loop filtering performing unit 230 may perform the in-loop filtering by distinguishing between the filter types that are classified according to a predetermined characteristic, by using the in-loop filtering performance information. For example, according to the in-loop filtering performance information used to classify filter types that are determined in consideration of an image characteristic of a filtering region, the in-loop filtering performing unit 230 may select a case in which in-loop filtering is not performed, a case in which a filter type for a flat region is used when the in-loop filtering is performed, a case in which a filter type for an edge region is used, and a case in which a filter type for a texture region is used, and may perform the in-loop filtering.

The in-loop filtering performing unit 230 may perform the in-loop filtering by distinguishing between filter types that are classified according to coding symbols by using the in-loop filtering performance information. The coding symbols may include a motion vector (MV), a Motion Vector Difference (MVD) value, a Coded Block Pattern (CBP), a prediction mode, and the like.

The in-loop filtering performing unit 230 may generate a filter for in-loop filtering according to the filter coefficient information. For example, the filter for in-loop filtering may be a Wiener filter. In a case where the filter coefficient information is difference information about a wiener filter coefficient, the in-loop filtering performing unit 230 may predict a current filter coefficient by using an existing filter coefficient and the difference information.

The in-loop filtering may be performed by using a two-dimensional filter or by serialone-dimensional filters.

A next picture may be prediction-decoded by referring to a current picture on which the in-loop filtering is performed by the in-loop filtering performing unit 230. In the video decoding apparatus 200 according to the present exemplary embodiment, the next picture is prediction-decoded by using a reference picture having undergone the in-loop filtering, so that an error between an original image and a restored image may be reduced.

FIG. 3 is a diagram for describing a concept of coding units according to a tree-structure according to an exemplary embodiment.

A size of a coding unit may be expressed in width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 3 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the vide data 310 may include a maximum coding unit having a long axis size of 64, and coding units having long axis sizes of 32 and 16 since depths are deepened to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are deepened to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are deepened to 3 layers by splitting the maximum coding unit three times. As a depth deepens, detailed information may be precisely expressed.

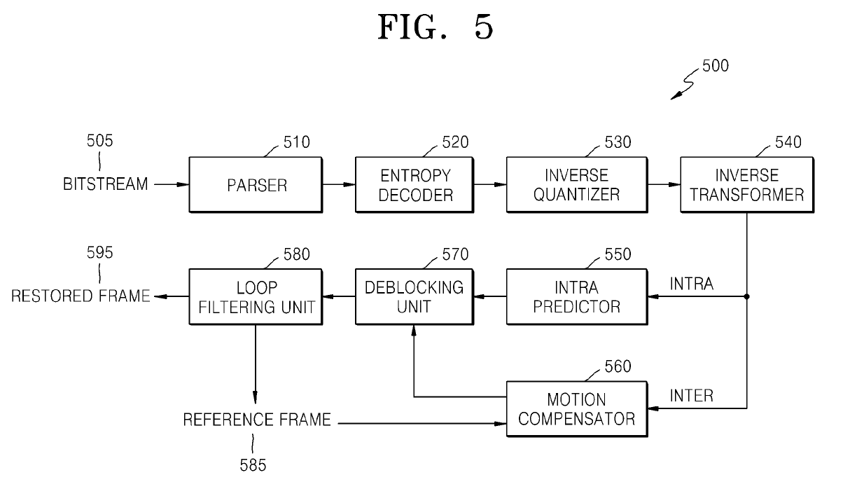

FIG. 4 is a block diagram of an image encoder 400 based on coding units according to a tree-structure, according to an exemplary embodiment. The image encoder 400 performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 performs inter estimation and motion compensation on coding units in an inter mode from among the current frame 405 by using the current frame 405, and a reference frame 495.

Data output from the intra predictor 410, the motion estimator 420, and the motion compensator 425 is output as a quantized transformation coefficient through a transformer 430 and a quantizer 440. The quantized transformation coefficient is restored as data in a spatial domain through an inverse quantizer 460 and an inverse transformer 470, and the restored data in the spatial domain is output as the reference frame 495 after being post-processed through a deblocking unit 480 and a loop filtering unit 490. The quantized transformation coefficient may be output as a bitstream 455 through an entropy encoder 450.

In order for the image encoder 400 to be applied in the video encoding apparatus 100, all elements of the image encoder 400, i.e., the intra predictor 410, the motion estimator 420, the motion compensator 425, the transformer 430, the quantizer 440, the entropy encoder 450, the inverse quantizer 460, the inverse transformer 470, the deblocking unit 480, and the loop filtering unit 490 perform operations based on each coding unit from among coding units having a tree structure while considering the maximum depth of each maximum coding unit.

Specifically, the intra predictor 410, the motion estimator 420, and the motion compensator 425 determines partitions and a prediction mode of each coding unit from among the coding units having a tree structure while considering the maximum size and the maximum depth of a current maximum coding unit, and the transformer 430 determines the size of the transformation unit in each coding unit from among the coding units having a tree structure.

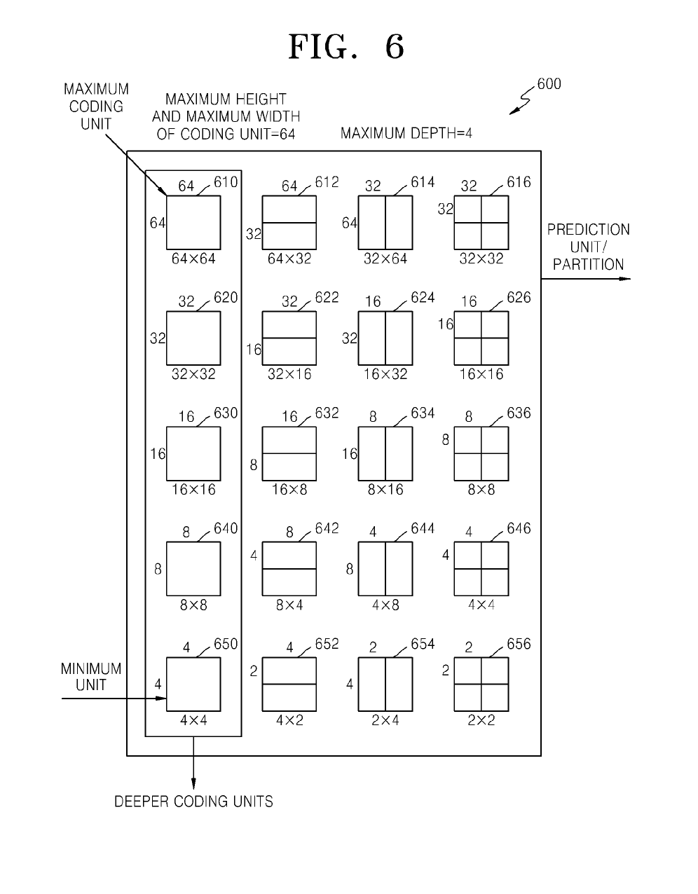

FIG. 5 is a block diagram of an image decoder 500 based on coding units according to a tree-structure, according to an exemplary embodiment. A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse transformer 540.

An intra predictor 550 performs intra prediction on coding units in an intra mode with respect to the image data in the spatial domain, and a motion compensator 560 performs motion compensation on coding units in an inter mode by using a reference frame 585.

The image data in the spatial domain, which passed through the intra predictor 550 and the motion compensator 560, may be output as a restored frame 595 after being post-processed through a deblocking unit 570 and a loop filtering unit 580. Also, the image data that is post-processed through the deblocking unit 570 and the loop filtering unit 580 may be output as the reference frame 585.

In order to decode the image data in the image data decoder 230 of the video decoding apparatus 200, the image decoder 500 may perform operations that are performed after the parser 510.

In order for the image decoder 500 to be applied in the video decoding apparatus 200, all elements of the image decoder 500, i.e., the parser 510, the entropy decoder 520, the inverse quantizer 530, the inverse transformer 540, the intra predictor 550, the motion compensator 560, the deblocking unit 570, and the loop filtering unit 580 perform operations based on coding units having a tree structure for each maximum coding unit.

Specifically, the intra predictor 550 and the motion compensator 560 perform operations based on partitions and a prediction mode for each of the coding units having a tree structure, and the inverse transformer 540 perform operations based on a size of a transformation unit for each coding unit.

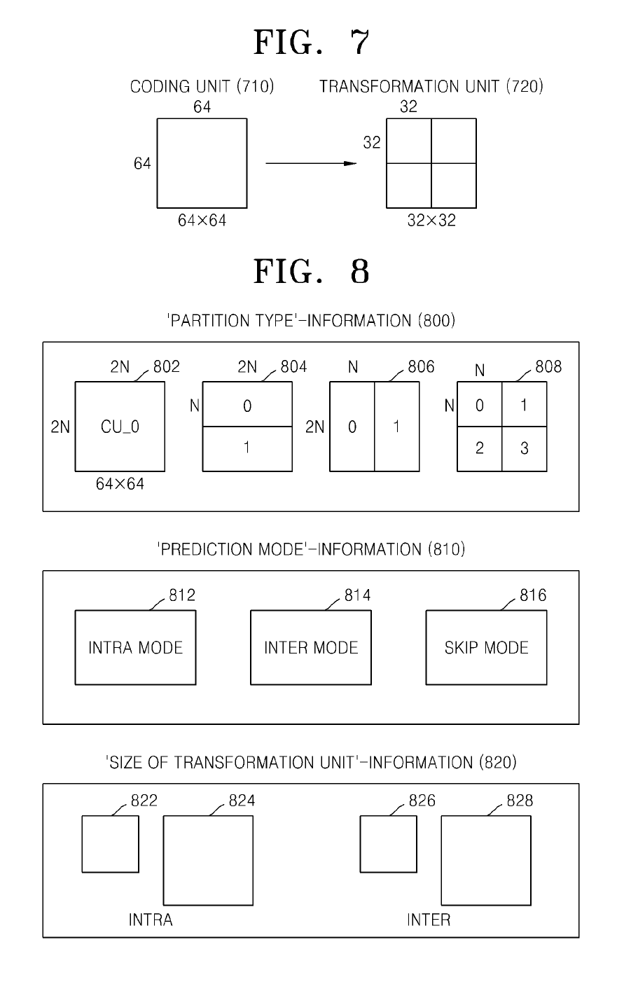

FIG. 6 is a diagram illustrating deeper coding units according to depths, and partitions, according to an exemplary embodiment. The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to an exemplary embodiment, the maximum height and the maximum width of the coding units are each 64, and the maximum depth is 4. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having the size of 4×4 and the depth of 4 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions include in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

The coding unit 650 having the size of 4×4 and the depth of 4 is the minimum coding unit and a coding unit of the lowermost depth. A prediction unit of the coding unit 650 is assigned to a partition having a size of 4×4. Also, the prediction unit of the coding unit 650 may include a partition having a size of 4×4 included in the coding unit 650, partitions 652 having a size of 4×2, partitions 654 having a size of 2×4, and partitions 656 having a size of 2×2.

In order to determine the at least one coded depth of the coding units constituting the maximum coding unit 610, the coding unit determiner 120 of the video encoding apparatus 100 performs encoding for coding units corresponding to each depth included in the maximum coding unit 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the coding unit 610 may be selected as the coded depth and a partition type of the coding unit 610.

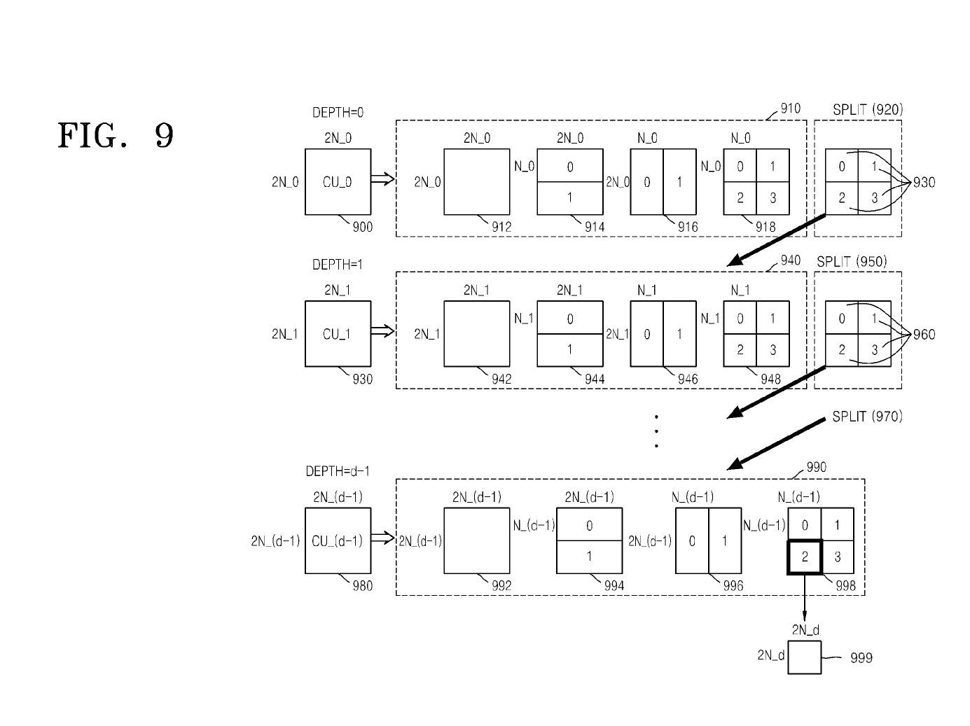

FIG. 7 is a diagram for describing a relationship between a coding unit 710 and transformation units 720, according to an exemplary embodiment. The video encoding apparatus 100 or 200 encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 or 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

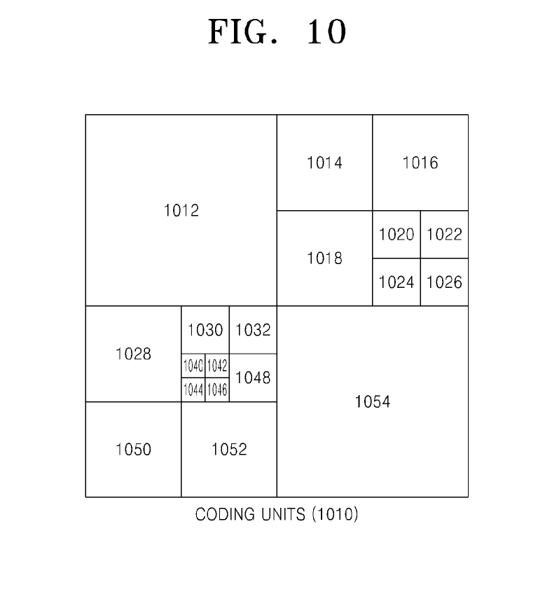

FIG. 8 is a diagram for describing encoding information of coding units corresponding to a coded depth, according to an exemplary embodiment. The output unit 130 of the video encoding apparatus 100 may encode and transmit information 800 about a partition type, information 810 about a prediction mode, and information 820 about a size of a transformation unit for each coding unit corresponding to a coded depth, as information about an encoding mode.

The information 800 indicates information about a shape of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second intra transformation unit 828.

The image data and encoding information extractor 220 of the video decoding apparatus 200 may extract and use the information 800, 810, and 820 for decoding, according to each deeper coding unit

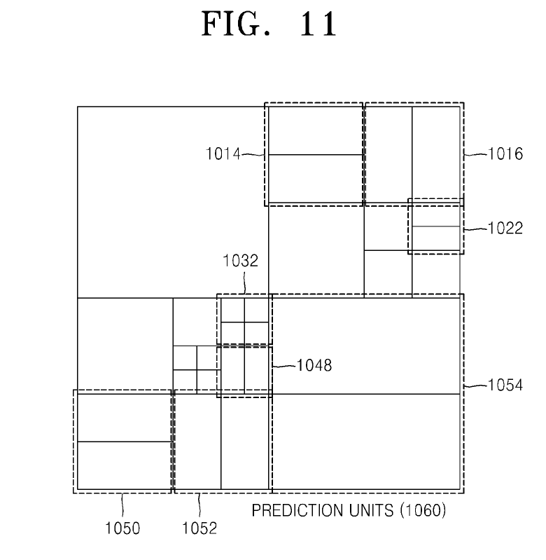

FIG. 9 is a diagram of deeper coding units according to depths, according to an exemplary embodiment. Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

Errors of encoding including the prediction encoding in the partition types 912 through 918 are compared, and the least encoding error is determined among the partition types. If an encoding error is smallest in one of the partition types 912 through 916, the prediction unit 910 may not be split into a lower depth.

If the encoding error is the smallest in the partition type 918, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (═N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed up to when a depth becomes d-1, and split information may be encoded as up to when a depth is one of 0 to d-2. In other words, when encoding is performed up to when the depth is d-1 after a coding unit corresponding to a depth of d-2 is split in operation 970, a prediction unit 990 for prediction encoding a coding unit 980 having a depth of d-1 and a size of 2N_(d-1)×2N_(d-1) may include partitions of a partition type 992 having a size of 2N_(d-1)×2N_(d-1), a partition type 994 having a size of 2N_(d-1)×N_(d-1), a partition type 996 having a size of N_(d-1)×2N_(d-1), and a partition type 998 having a size of N_(d-1)×N_(d-1).

Prediction encoding may be repeatedly performed on one partition having a size of 2N_(d-1)×2N_(d-1), two partitions having a size of 2N_(d-1)×N_(d-1), two partitions having a size of N_(d-1)×2N_(d-1), four partitions having a size of N_(d-1)×N_(d-1) from among the partition types 992 through 998 to search for a partition type having a minimum encoding error.

Even when the partition type 998 has the minimum encoding error, since a maximum depth is d, a coding unit CU_(d-1) having a depth of d-1 is no longer split to a lower depth, and a coded depth for the coding units constituting a current maximum coding unit 900 is determined to be d-1 and a partition type of the current maximum coding unit 900 may be determined to be N_(d-1)×N_(d-1). Also, since the maximum depth is d and a minimum coding unit 980 having a lowermost depth of d-1 is no longer split to a lower depth, split information for the minimum coding unit 980 is not set.

A data unit 999 may be a ‘minimum unit’ for the current maximum coding unit. A minimum unit according to an exemplary embodiment may be a rectangular data unit obtained by splitting a minimum coding unit 980 by 4. By performing the encoding repeatedly, the video encoding apparatus 100 may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only split information of the coded depth is set to 0, and split information of depths excluding the coded depth is set to 1.

The image data and encoding information extractor 220 of the video decoding apparatus 200 may extract and use the information about the coded depth and the prediction unit of the coding unit 900 to decode the partition 912. The video decoding apparatus 200 may determine a depth, in which split information is 0, as a coded depth by using split information according to depths, and use information about an encoding mode of the corresponding depth for decoding.

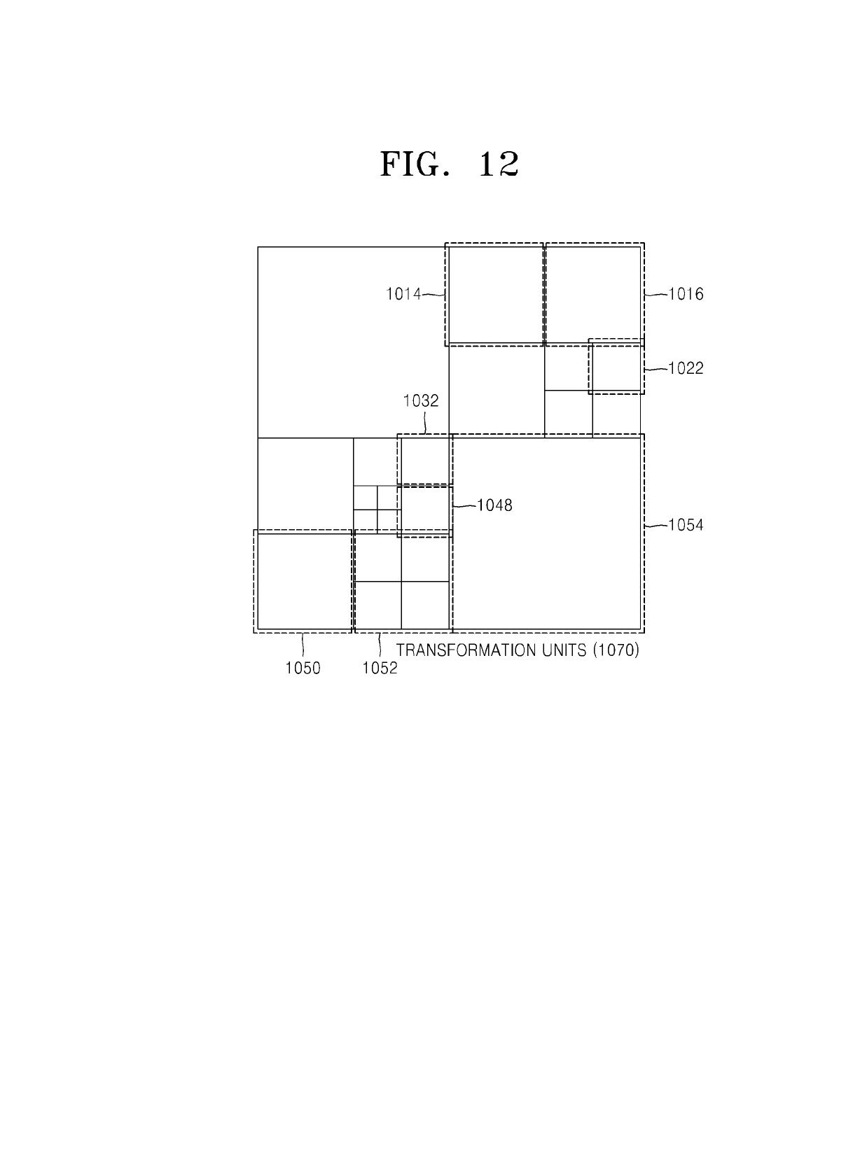

FIGS. 10 through 12 are diagrams for describing a relationship between coding units 1010, prediction units 1060, and transformation units 1070, according to an exemplary embodiment. The coding units 1010 are coding units having a tree structure, corresponding to coded depths determined by the video encoding apparatus 100, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding and decoding apparatuses 100 and 200 may perform intra prediction, motion estimation, motion compensation, transformation, and inverse transformation individually on a data unit in the same coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding and decoding apparatuses 100 and 200.

TABLE 1

| Split Information 0 | | | | | |
|---|---|---|---|---|---|
| (Encoding on Coding Unit Having Size of 2Nx2N and Current Depth of d) | | | | | |
| Prediction | | | | | Split |
| Mode | Partition Type | | Size of Transformation Unit | | Information 1 |
| Intra | Symmetrical | Asymmetrical | Split | Split | Repeatedly |
| Inter | Partition | Partition | Information 0 | Information 1 | Encode |
| Skip | Type | Type | of | of | Coding Units |
| (Only | 2Nx2N | 2NxnU | Transformation | Transformation | Having |
| 2Nx2N) | 2NxN | 2NxnD | Unit | Unit | Lower Depth |
| | Nx2N | nLx2N | 2Nx2N | NxN | of d + 1 |
| | NxN | nRx2N | | (Symmetrical | |
| | | | | Type) | |
| | | | | N/2xN/2 | |
| | | | | (Asymmetrical | |
| | | | | Type) | |

The output unit 130 of the video encoding apparatus 100 may output the encoding information about the coding units having a tree structure, and the image data and encoding information extractor 220 of the video decoding apparatus 200 may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

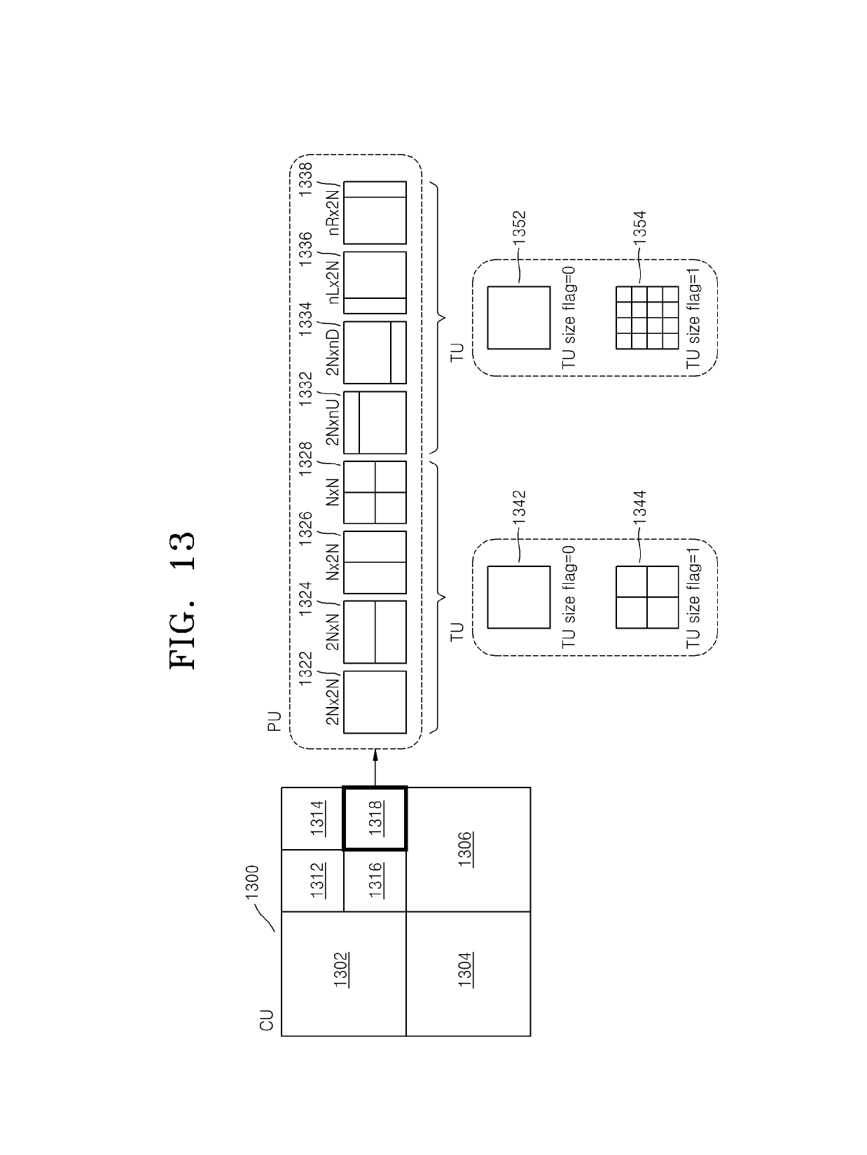

FIG. 13 is a diagram for describing a relationship between a coding unit, a prediction unit or a partition, and a transformation unit, according to encoding mode information of Table 1. A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

When the partition type is set to be symmetrical, i.e. the partition type 1322, 1324, 1326, or 1328, a transformation unit 1342 having a size of 2N×2N is set if split information (TU size flag) of a transformation unit is 0, and a transformation unit 1344 having a size of N×N is set if a TU size flag is 1.

When the partition type is set to be asymmetrical, i.e., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

Referring to FIG. 13, the TU size flag is a flag having a value or 0 or 1, but the TU size flag is not limited to 1 bit, and a transformation unit may be hierarchically split having a tree structure while the TU size flag increases from 0.

FIG. 14 is a block diagram of a video encoding and decoding system 1400 performing in-loop filtering.

An encoder 1410 of the video encoding and decoding system 1400 transmits an encoded datastream of a video, and a decoder 1450 receives and decodes the datastream and outputs a restored image.

A predictor 1415 of the encoder 1410 outputs a reference image by performing inter prediction and intra prediction. A residual component between the reference image and a current input image passes through a transform/quantization unit 1420 and then is output as a quantized transformation coefficient. The quantized transformation coefficient passes through an entropy encoder 1425 and then is output as a decoded datastream. The quantized transformation coefficient passes through an inverse-quantization/inverse-transform unit 1430 and then is restored as data of a spatial domain, and the restored data of the spatial domain passes through a deblocking filter 1435 and a loop filtering unit 1440 and then is output as a restored image. The restored image may pass through the predictor 1415 and then may be used as a reference image for a next input image.

Encoded image data of the datastream received by the decoder 1450 passes through an entropy decoder 1455 and an inverse-quantization/inverse-transform unit 1460 and then is restored as a residual component of a spatial domain. Image data of the spatial domain is created by synthesizing a reference image output from a predictor 1475 and the residual component, and a restored image of a current original image may be output by passing through a deblocking filter 1465 and a loop filtering unit 1470. The restored image may be used as a reference image for a next original image.

The loop filtering unit 1440 of the video encoding and decoding system 1400 performs loop filtering by using filter information according to a user input or a system setting. The filter information used by the loop filtering unit 1440 is output to the entropy encoder 1425 and then the filter information and the encoded image data are transmitted to the decoder 1450. The loop filtering unit 1470 of the decoder 1450 may perform loop filtering based on the filter information received from the decoder 1450.

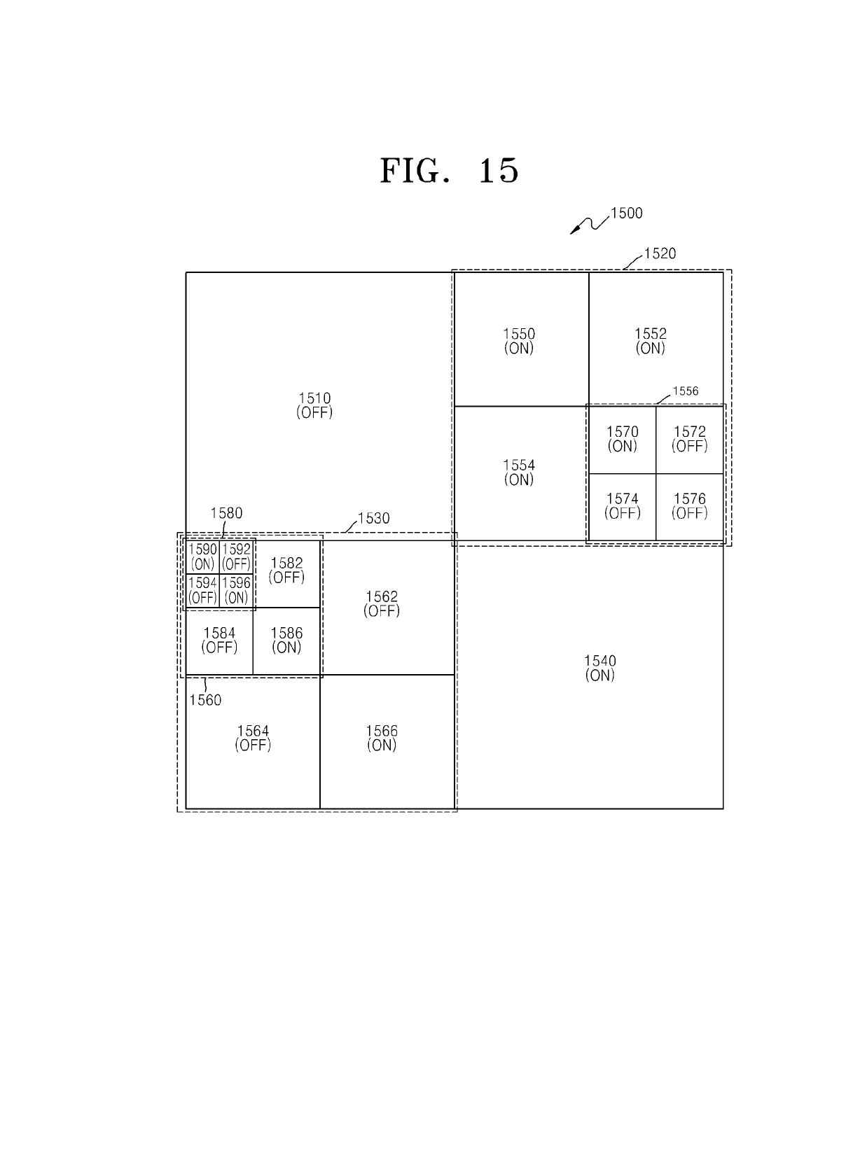

FIGS. 15 and 16 illustrate an example of filtering units according to a tree-structure 1600 which are included in a maximum coding unit 1500, filtering unit spilt information, and filtering performance information, according to an exemplary embodiment.

When filtering units of the loop filtering unit 1440 of the encoder 1410 and the loop filtering unit 1470 of the decoder 1450 are formed as data units that are hierarchical according to regions in the maximum coding unit 1500, like the coding units according to the tree-structure described in the previous exemplary embodiment, filter information may include split flags of data units so as to indicate the filtering units according to the tree-structure 1600, and include loop filtering flags indicating performance of loop filtering on the filtering units.

The filtering units according to the tree-structure 1600 which are included in the maximum coding unit 1500 hierarchically include filtering units 1510 and 1540 of a layer 1, filtering units 1550, 1552, 1554, 1562, 1564 and 1566 of a layer 2, filtering units 1570, 1572, 1574, 1576, 1592, 1594 and 1596 of a layer 3, and filtering units 1580, 1582, 1584 and 1586 of a layer 4.

The tree-structure 1600 of the filtering units included in the maximum coding unit 1500 shows the split flags according to layers of the data units and filtering flags. A round-shape flag indicates the split flag with respect to a corresponding data unit, and a diamond-shape flag indicates the filtering flag.

Respective reference numerals beside respective round-shape flags indicate the data units in the maximum coding unit 1500. If the round-shape flag is 1, this means that a data unit of a current layer is split into data units of a lower layer, and if the round-shape flag is 0, this means that a data unit of a current layer is not split any more and is determined as a filtering unit.

Since the filtering flags are determined according to the filtering units, the diamond-shape flag is set only when the round-shape flag is 0. If the diamond-shape flag is 1, this means that loop filtering is performed on a corresponding filtering unit, and if the diamond-shape flag is 0, this means that loop filtering is not performed.

In a case where the maximum coding unit 1500 includes five filtering layers of 0, 1, 2, 3, and 4, spilt information and performance of loop filtering may be encoded as shown in Table 2 below.

TABLE 2

| Layer | Spilt information | Performance of loop filtering |
|---|---|---|
| 0 | 1(1500) | |
| 1 | 0(1510) 1(1520) 1(1530) 0(1540) | 0(1610) 1(1640) |
| 2 | 0(1550) 0(1552) 0(1554) 1(1556) | 1(1650) 1(1652) 1(1654) 0(1662) |
| | 1(1560) 0(1562) 0(1564) 0(1566) | 0(1664) 1(1666) |
| 3 | 0(1570) 0(1572) 0(1574) 0(1576) | 1(1670) 0(1672) 0(1674) 0(1676) |
| | 1(1580) 0(1582) 0(1584) 0(1586) | 0(1682) 0(1684) 1(1686) |
| 4 | 0(1590) 0(1592) 0(1594) 0(1596) | 1(1690) 0(1692) 0(1694) 1(1696) |

That is, the split flags according to layers of the data units are encoded and transmitted as the filter information so as to determine the filtering units according to the tree-structure 1600 which are to be filtered by the loop filtering unit 1440 and the loop filtering unit 1470.

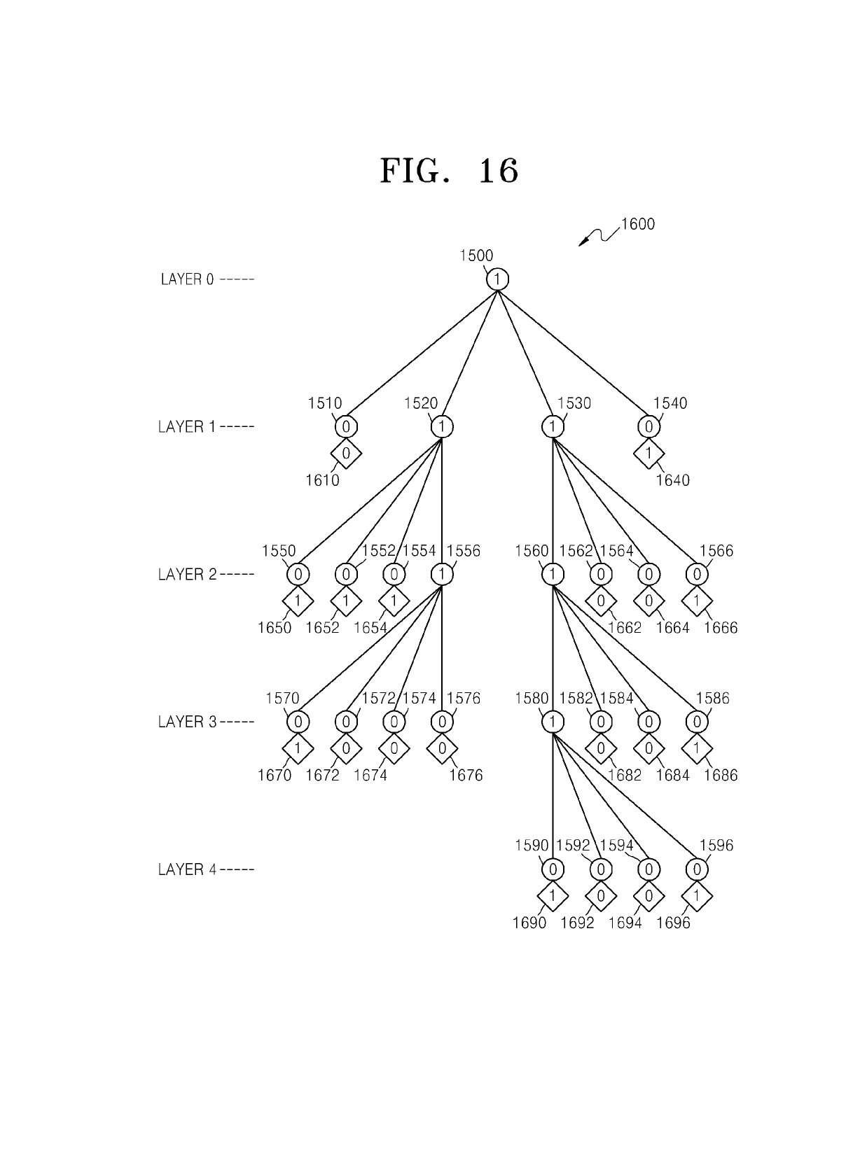

The coding units according to the tree-structure are formed as shapes to minimize an error between an original image corresponding to the maximum coding unit 1500 and a restored image by decoding based on the coding units according to the tree-structure, so that spatial correlation of pixels inside a coding unit is improved. Thus, by determining the filtering units based on the coding units, an operation for determining the filtering units, which is separate from determination of the coding units, may be omitted. Also, by determining the filtering units based on the coding units according to the tree-structure, the split flags according to layers of the filtering units may be omitted, so that it is possible to reduce a transmission bitrate with respect to the filter information. Hereinafter, a method of determining the filtering units, and the filter information according to an exemplary embodiment will be described in detail with reference to FIGS. 17 through 22.

FIG. 17 illustrates maximum coding units, and data units including partitions and including coding units according to a tree-structure which are included in each of the maximum coding units, according to an exemplary embodiment.

A data unit group 1700 includes coding units according to a coded depth of 9 maximum coding units each having a size of 32×32. Also, each of the maximum coding units includes the coding units according to the tree-structure and the partitions. The coding units according to the coded depth are denoted by using a solid line, and the partitions that are obtained by splitting the coding units according to the coded depth are denoted by using a dotted line. The coded depth of the coding units according to the tree-structure may include 0, 1, and 2, and a maximum depth corresponding to the number of maximum hierarchical layers may be set as 3.

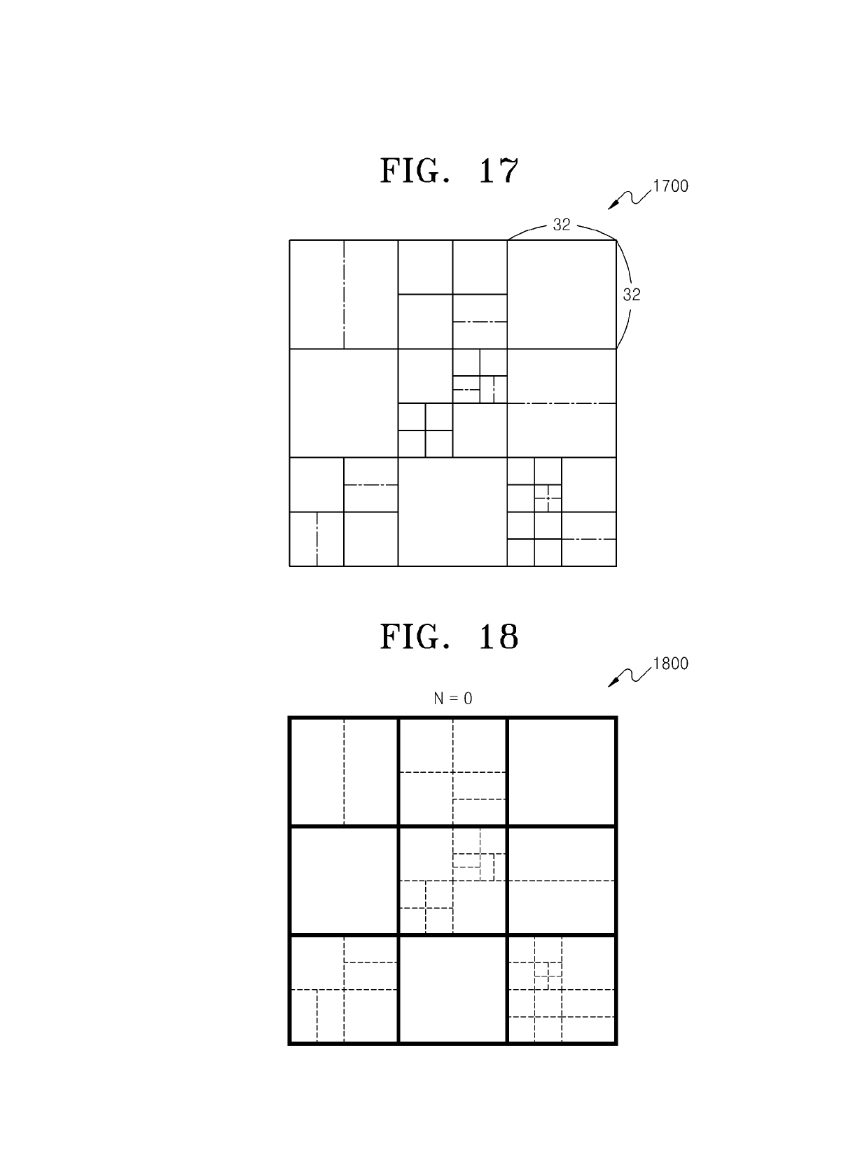

FIGS. 18 through 21 respectively illustrate filtering units of filtering layers 0, 1, 2, and 3 with respect to the data units of FIG. 17.

The in-loop filtering unit 120 and the in-loop filtering performing unit 230 may determine a filtering layer among layers according to depths and partition layers of each coding unit from among the partitions and the coding units according to the tree-structure of the maximum coding units, and may determine data units according to layers as filtering units, wherein the data units according to layers are from each of the maximum coding units to data units of the determined filtering layer.

The in-loop filtering unit 120 and the in-loop filtering performing unit 230 use the filtering layer to determine the filtering units. For example, referring to a data group 1700, the same filtering layer information may be set to 9 maximum coding units. According to the filtering layer information, coding units from a maximum coding unit to a depth of a filtering layer may be determined as the filtering units, wherein the coding units are from among coding units according to a depth 0 through to a coded depth. However, coding units according to the coded depth are not split into a lower depth according to a filtering layer.

In more detail, in a case of the filtering layer 0, coding units according to a depth of 0, that is, maximum coding units, may be determined as filtering units. Thus, a filtering unit group 1800 may include the coding units according to the depth of 0.

In a case of the filtering layer 1, maximum coding units through to coding units according to a depth of 1 may be determined as filtering units. Thus, a filtering unit group 1900 may include coding units according to a depth of 0 and the coding units according to the depth of 1. However, the coding units according to the depth of 1 are not included in a maximum coding unit according to a depth of 0.

In a case of the filtering layer 2, maximum coding units through to coding units according to a depth of 2 may be determined as filtering units. Thus, a filtering unit group 2000 may include coding units according to a depth of 0, coding units according to a depth of 1, and the coding units according to the depth of 2. However, the coding units according to the depth of 1 and the coding units according to the depth of 2 are not included in a maximum coding unit according to a depth of 0, and the coding units according to the depth of 2 are not included in the coding units according to the depth of 1.

In a case of the filtering layer 3, a filtering layer may correspond to a maximum depth of a coded depth, and maximum coding units, coding units according to all depths, and partitions may be determined as filtering units. Thus, a filtering unit group 2100 may include coding units according to a depth of 0, coding units according to a depth of 1, coding units according to a depth of 2, and the partitions. Similarly, the coding units according to the depth of 1 and the coding units according to the depth of 2 are not included in a maximum coding unit according to a depth of 0, and the coding units according to the depth of 2 are not included in the coding units according to the depth of 1.

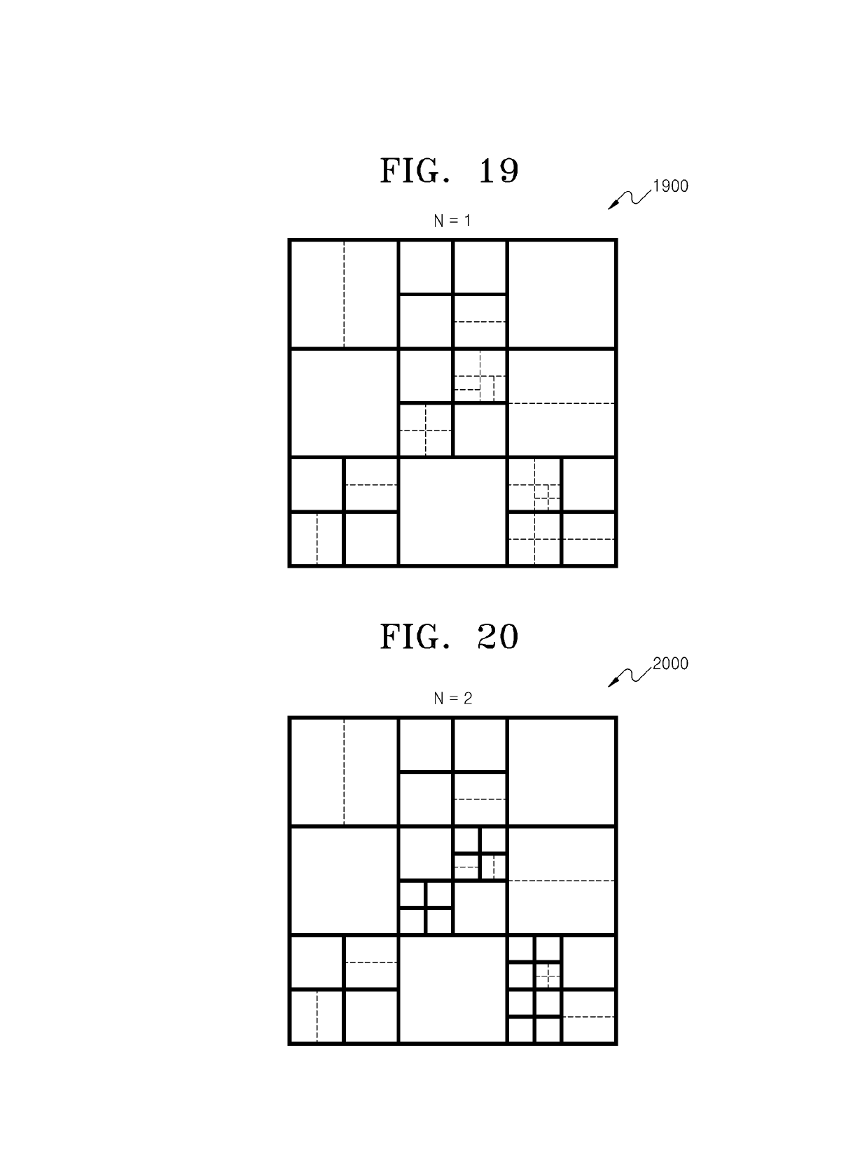

FIG. 22 illustrates the filtering units of the filtering layer 1 and in-loop filtering performance information with respect to the data units of FIG. 17.

In a case where a filtering layer is set as 1, the filtering unit group 1900 may be finally determined as a filtering unit group 2200. Thus, filtering units of the filtering unit group 2200 include data units according to the depth of 0 and the coding units according to the depth of 1, and the in-loop filtering performance information may be set to each of the filtering units. The in-loop filtering performance information of FIG. 22 is a flag indicating whether to perform in-loop filtering on a corresponding filtering unit, and the in-loop filtering performance information of 0 or 1 may be applied to each of the filtering units of the filtering unit group 2200. In this case, information about the filtering units of the filtering unit group 2200 may include filtering layer information indicating the filtering layer 1 and the in-loop filtering performance information in the form of a flag.

The in-loop filtering performance information may be set to indicate not only performance of in-loop filtering but also to indicate a filter type selected from a plurality of filter types. For example, in a case where the in-loop filtering performance information indicates 0, 1, 2, and 3, respectively, the in-loop filtering performance information may define ‘a case in which the in-loop filtering is not performed’, ‘a case in which a filter type 1 is used’, ‘a case in which a filter type 2 is used’, and ‘a case in which a filter type 3 is used’, respectively.

Also, the in-loop filtering performance information may be set to distinguish between filter types that are classified according to predetermined image characteristics of the filtering units. For example, in consideration of an image characteristic of a filtering region, the in-loop filtering performance information may be set to indicate a case in which in-loop filtering is not performed or another case in which in-loop filtering is performed, wherein the other case is divided into ‘a case in which a filter type for a flat region is used’, ‘a case in which a filter type for an edge region is used’, and ‘a case in which a filter type for a texture region is used’.

In addition, the in-loop filtering performance information may be set to distinguish between filter types that are classified according to coding symbols. The coding symbols include a motion vector (MV), a Motion Vector Difference (MVD) value, a Coded Block Pattern (CBP), a prediction mode, and the like.

The MVD value indicates a total sum of absolute values of a vertical component and a horizontal component of a MVD. Also, if a non-zero quantized coefficient exits in a current region, coding block pattern information is set as 1, and if the non-zero quantized coefficient does not exit, the coding block pattern information is set as 0.

The coding symbols are generated as a result of image encoding, thus, regions having similar coding symbols set thereto may have a similar image characteristic. For example, in general, a region in which a MVD value is greater than a predetermined threshold value or the coding block pattern information is set as 1 may have many texture components, and a region in which the MVD value is smaller than the predetermined threshold value or the coding block pattern information is set as 0 may be a region in which a quantization error is minimized since prediction encoding is precisely performed or may be a flat region.

Thus, a filter type for a predetermined filtering unit may be classified into a filter for a region in which the MVD value of the filtering unit is smaller than the predetermined threshold value, and a filter for a region in which the MVD value of the filtering unit is greater than the predetermined threshold value. Also, the filter type for the predetermined filtering unit may be classified into a filter for a region in which the coding block pattern information is set as 0, and a filter for a region in which the coding block pattern information is set as 1. Also, according to 4 combinations of conditions with respect to the MVD value and the coding block pattern information, the filter type for the predetermined filtering unit may be classified into a filter for a region in which the MVD value is smaller than the predetermined threshold value and the coding block pattern information is set as 0, a filter for a region in which the MVD value is smaller than the predetermined threshold value and the coding block pattern information is set as 1, a filter for a region in which the MVD value is greater than the predetermined threshold value and the coding block pattern information is set as 0, and a filter for a region in which the MVD value is greater than the predetermined threshold value and the coding block pattern information is set as 1.

Since the prediction mode is information generated as a result of performing encoding in consideration of a spatial-temporal characteristic of an image, the filter type may be determined according to the prediction mode of the filtering units.

The in-loop filtering unit 120 of the video encoding apparatus 100 may set filter information to each filtering unit, wherein the filter information includes the filtering layer information about the coding units according to the tree-structure, the in-loop filtering performance information, the filter coefficient information for in-loop filtering, and the information about the upper-limit layer and the lower-limit layer of the filtering layer. The transmitting unit 130 of the video encoding apparatus 100 may transmit information about in-loop filtering, encoded data, and encoding information about coding units.

The receiving and extracting unit 210 of the video decoding apparatus 200 may recognize the filtering units based on the filter information, may analyze performance of filtering or the filter type of each filtering unit, and may perform in-loop filtering.

Thus, a calculation to separately determine the filtering units for in-loop filtering from the coding units is reduced, and the filtering units are set by using only the filtering layer information without using split information according to layers, so that the transmission bitrate may also be reduced.

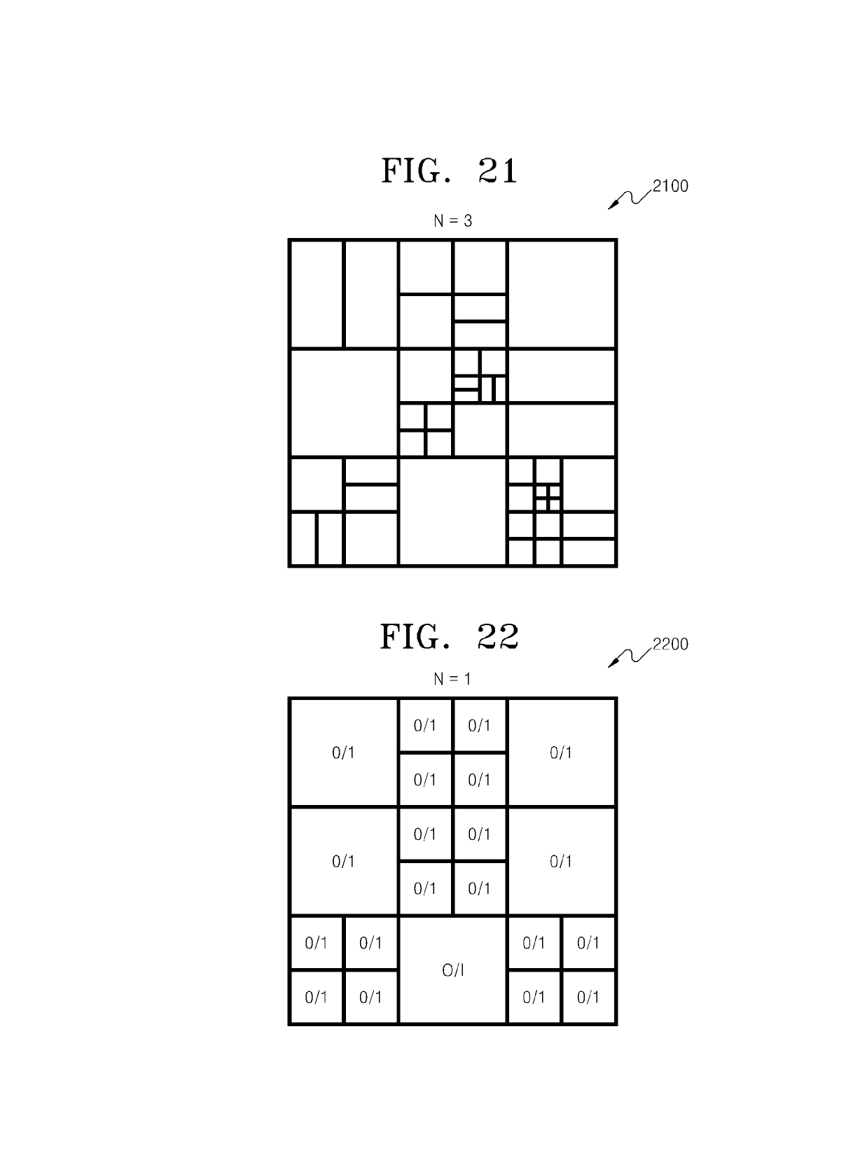

FIG. 23 is a flowchart of a method of encoding a video by performing in-loop filtering based on coding units according to a tree-structure, according to an exemplary embodiment.

In operation 2310, a picture is split into maximum coding units that are data units each having a maximum size. In operation 2320, coding units according to a coded depth are separately determined for deeper coding units according to depths included in each maximum coding unit, so that the coding units according to the tree-structure are determined.

In operation 2330, filtering units for performing in-loop filtering are determined based on the coding units according to the tree-structure of each maximum coding unit, and then the in-loop filtering is performed based on the filtering units.

In operation 2340, information about the in-loop filtering is encoded, and the encoded information about the in-loop filtering, encoded data of the picture, and encoded mode information about the coding units according to the tree-structure of each maximum coding unit are transmitted according to the filtering units. Filter information according to an exemplary embodiment may include filtering layer information, filtering performance information, filter coefficient information, and information about an upper-limit layer and a lower-limit layer of a filtering layer.

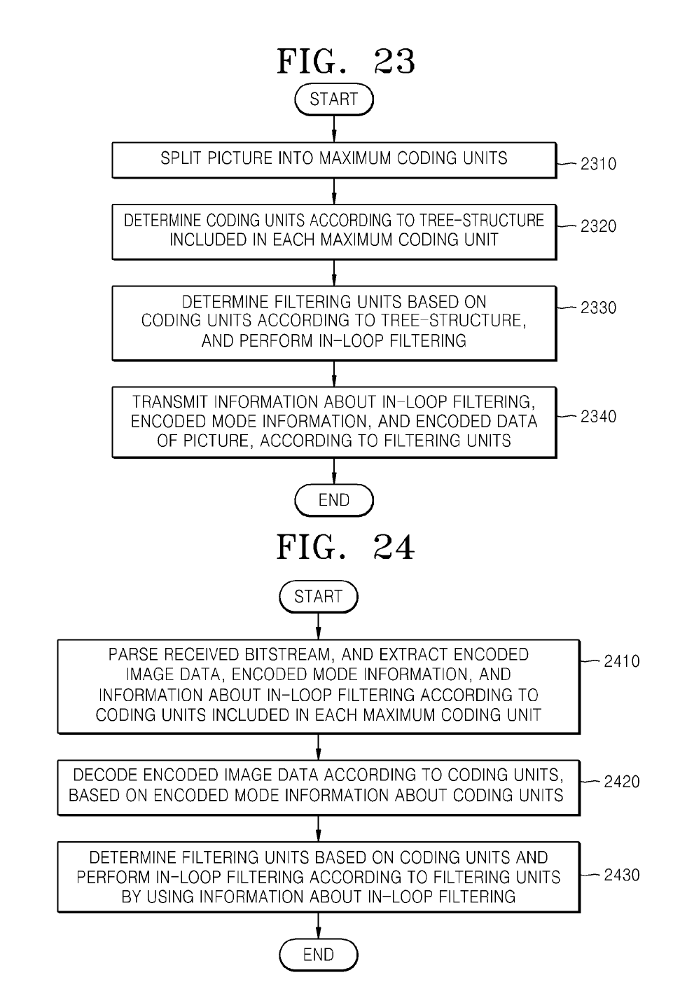

FIG. 24 is a flowchart of a method of decoding a video by performing in-loop filtering based on coding units according to a tree-structure, according to another exemplary embodiment.

In operation 2410, a received bitstream is parsed, and encoded image data, encoded mode information about coding units according to a tree-structure, and information about in-loop filtering of each maximum coding unit are extracted for each of the coding units according to the tree-structure which are included in each maximum coding unit of a current picture. Filtering layer information, filtering performance information, filter coefficient information, and information about an upper-limit layer and a lower-limit layer of a filtering layer may be extracted as filter information.

In operation 2420, based on the encoded mode information about the coding units according to the tree-structure which is extracted for each maximum coding unit, encoded image data is decoded according to the coding units. In operation 2430, by using the extracted information about in-loop filtering, filtering units for in-loop filtering are determined based on the coding units according to the tree-structure of each maximum coding unit, and the in-loop filtering is performed on the decoded image data of each maximum coding unit according to the filtering units.

Exemplary embodiments can be written as computer programs and can be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs). Moreover, one or more units of the above-described apparatuses and systems can include a processor or microprocessor executing a computer program stored in a computer-readable medium.

While exemplary embodiments have been particularly shown and described with reference to the drawings, it will be understood by those of ordinary skill in the art that various changes in form and details may be made therein without departing from the spirit and scope of the inventive concept as defined by the appended claims. The exemplary embodiments should be considered in a descriptive sense only and not for purposes of limitation. Therefore, the scope of the invention is defined not by the detailed description of exemplary embodiments, but by the appended claims, and all differences within the scope will be construed as being included in the present invention.

What is claimed is:

1. A method of encoding a video by performing in-loop filtering based on coding units, the method comprising:
splitting a picture into a maximum coding unit that is a data unit, wherein the maximum coding unit has a maximum size;
separately determining coding units to output encoding results according to a coded depth for deeper coding units that are hierarchically structured according to depths indicating a number of times the coding units are spatially split from the maximum coding unit, the coding units determined according to a tree-structure, wherein the coding units are hierarchical according to the depths in one region in the maximum coding unit and are independent according to the coded depth in other regions;
determining a filtering unit to perform in-loop filtering so as to minimize an error between the maximum coding unit and an original picture, based on the coding units according to the tree-structure of the maximum coding unit; and
performing the in-loop filtering based on the determined filtering unit.

2. The method of claim 1, wherein the determining the filtering unit comprises determining the filtering unit based on the coding units according to the tree-structure of the maximum coding unit.

3. The method of claim 1, wherein the determining the filtering unit comprises determining the filtering unit based on the coding units according to the tree-structure of the maximum coding unit and based on partitions that are data units for prediction encoding of each coding unit according to a coded depth.

4. The method of claim 2, wherein the determining the filtering unit based on the coding units comprises determining a data unit as the filtering unit, wherein the data unit is obtained by splitting or merging one or more of the coding units according to the tree-structure.

5. The method of claim 2, wherein the determining the filtering unit based on the coding units comprises using the coding units according to the tree-structure as prediction values of the filtering unit.

6. The method of claim 2, wherein the determining the filtering unit based on the coding units comprises determining a filtering layer from among layers according to depths of the coding units according to the tree-structure, and determining hierarchical data units up to the determined filtering layer as the filtering unit.

7. The method of claim 6, wherein the filtering layer is determined as one of layers from an initial layer of the maximum coding unit to a final layer indicating a lowermost depth from among the coding units according to the tree-structure of the maximum coding unit.

8. The method of claim 7, wherein the filtering layer is determined as one of layers from an upper-limit layer to a lower-limit layer set between the initial layer and the final layer.

9. The method of claim 2, further comprising encoding information about the in-loop filtering and transmitting the encoded information about the in-loop filtering, encoded data of the picture, and encoded mode information about the coding units according to the tree-structure of the maximum coding unit, according to the filtering unit.

10. The method of claim 7, wherein the information about the in-loop filtering comprises at least one of filtering layer information about a filtering layer determined as one of layers of the deeper coding units so as to determine filtering units with respect to the coding units according to the tree-structure, in-loop filtering performance information indicating performance of the in-loop filtering for the filtering units, filter coefficient information for the in-loop filtering, and information about an upper-limit layer and a lower-limit layer of the filtering layer.

11. The method of claim 2, wherein the performing the in-loop filtering comprises setting in-loop filtering performance information indicating performance of the in-loop filtering for the filtering unit.

12. The method of claim 2, wherein the determining the filtering unit based on the coding units comprises separately determining a filtering unit for a luma component of a color component, and a filtering unit for a chroma component of the color component.

13. The method of claim 2, wherein the determining the filtering unit based on the coding units comprises predicting a filtering unit for a chroma component by referring to a filtering unit for a luma component of a color component.

14. The method of claim 2, wherein the determining the filtering unit based on the coding units comprises applying a same filtering unit to all of maximum coding units in the picture.

15. The method of claim 2, wherein filtering units are separately determined according to one of data units comprising the picture, a sequence of the picture, a frame, a field, and a maximum coding unit.

16. The method of claim 2, wherein the performing the in-loop filtering comprises performing the in-loop filtering by selecting a filter type from among a plurality of filter types.

17. The method of claim 16, wherein:
the performing the in-loop filtering further comprises setting in-loop filtering performance information for each of filtering units; and
the in-loop filtering performance information indicates performance of the in-loop filtering and indicates the filter type selected from the plurality of filter types.

18. The method of claim 11, wherein the in-loop filtering performance information comprises a flag for distinguishing a case in which in-loop filtering using a predetermined filter type is performed from a case in which in-loop filtering using the predetermined filter type is not performed.

19. The method of claim 11, wherein the in-loop filtering performance information is set so as to distinguish between filter types classified according to predetermined image characteristics of filtering units.

20. The method of claim 11, wherein the in-loop filtering performance information is set so as to distinguish between filter types classified according to coding symbols of filtering units.

21. The method of claim 2, wherein the performing the in-loop filtering comprises generating a filter coefficient so as to perform the in-loop filtering on the filtering unit.

22. The method of claim 9, wherein the transmitting comprises inserting the in-loop filtering information into a Sequence Parameter Set (SPS) or a Picture Parameter Set (PPS) of the picture and transmitting the inserted in-loop filtering information.

23. A method of decoding a video by performing in-loop filtering based on coding units, the method comprising:
parsing a received bitstream and extracting image data encoded for each of coding units based on the coding units according to a tree-structure which are comprised in a maximum coding unit obtained by splitting a current picture, extracting encoded mode information about the coding units according to the tree-structure, and extracting information about in-loop filtering of the maximum coding unit;
decoding the extracted image data, based on the extracted encoded mode information which is extracted for the maximum coding unit;
determining, using the extracted information about in-loop filtering, a filtering unit for the in-loop filtering based on the coding units according to the tree-structure of the maximum coding unit; and
performing the in-loop filtering on the decoded image data of the maximum coding unit according to the filtering unit.

24. The method of claim 23, wherein the determining the filtering unit comprises determining the filtering unit based on the coding units according to the tree-structure of the maximum coding unit, by referring to the extracted information about in-loop filtering.

25. The method of claim 23, wherein the determining the filtering unit comprises determining the filtering unit based on the coding units according to the tree-structure of the maximum coding unit and based on partitions that are data units for prediction encoding of each coding unit according to a coded depth, by referring to the extracted information about in-loop filtering.

26. The method of claim 24, wherein the determining the filtering unit based on the coding units comprises determining a data unit as the filtering unit, wherein the data unit is obtained by splitting or merging one or more of the coding units according to the tree-structure, by referring to the extracted information about in-loop filtering.

27. The method of claim 24, wherein the determining the filtering unit based on the coding units comprises using the coding units according to the tree-structure as prediction values of the filtering unit, by referring to the extracted information about in-loop filtering.

28. The method of claim 24, wherein the information about the in-loop filtering comprises at least one of filtering layer information about a filtering layer determined as one of layers of the deeper coding units so as to determine filtering units with respect to the coding units according to the tree-structure, in-loop filtering performance information indicating performance of the in-loop filtering for the filtering units, filter coefficient information for the in-loop filtering, and information about an upper-limit layer and a lower-limit layer of the filtering layer.

29. The method of claim 28, wherein the determining the filtering unit comprises determining hierarchical data units up to the filtering layer as the filtering unit, according to the filtering layer information.

30. The method of claim 28, wherein the filtering layer is determined as one of layers from an initial layer of the maximum coding unit to a final layer indicating a lowermost depth from among the coding units according to the tree-structure of the maximum coding unit.

31. The method of claim 30, wherein the filtering layer is determined as one of layers from an upper-limit layer to a lower-limit layer set between the final layer and the initial layer of the maximum coding unit.

32. The method of claim 28, wherein the performing the in-loop filtering comprises determining performance of in-loop filtering for each of the coding units according to the tree-structure of the maximum coding unit, based on the in-loop filtering performance information.

33. The method of claim 24, wherein:
the determining the filtering unit based on the coding units comprises separately determining a filtering unit for a luma component of a color component and a filtering unit for a chroma component of the color component according to in-loop filtering performance information; and
the performing the in-loop filtering comprises performing the in-loop filtering for each of the luma component and the chroma component.

34. The method of claim 24, wherein:
the determining the filtering unit based on the coding units comprises predicting a filtering unit for a chroma component by referring to a filtering unit for a luma component of a color component, according to in-loop filtering performance information; and
the performing the in-loop filtering comprises performing the in-loop filtering for each of the luma component and the chroma component.

35. The method of claim 24, wherein the determining the filtering unit based on the coding units comprises applying a same filtering unit to all of maximum coding units in the current picture.

36. The method of claim 24, wherein filtering units are separately determined according to one of data units comprising a picture, a sequence of the picture, a frame, a field, and a maximum coding unit.

37. The method of claim 28, wherein the performing the in-loop filtering comprises performing the in-loop filtering by selecting a filter type from among a plurality of filter types, based on the in-loop filtering performance information.

38. The method of claim 37, wherein the performing the in-loop filtering further comprises setting the in-loop filtering performance information for each of filtering units, based on the in-loop filtering performance information, and if the in-loop filtering is performed.

39. The method of claim 38, wherein the in-loop filtering performance information comprises a flag for distinguishing a case in which in-loop filtering using a predetermined filter type is performed from a case in which in-loop filtering using the predetermined filter type is not performed.

40. The method of claim 38, wherein the in-loop filtering performance information is set so as to distinguish between filter types classified according to predetermined image characteristics of the filtering units.

41. The method of claim 38, wherein the in-loop filtering performance information is set so as to distinguish between filter types classified according to coding symbols of the filtering units.

42. The method of claim 39, wherein the performing the in-loop filtering further comprises generating a filter coefficient so as to perform the in-loop filtering on the filtering unit, based on the filter coefficient information.

43. The method of claim 23, wherein the extracting comprises extracting the information about in-loop filtering, the encoded image data, and the encoded mode information about the coding units according to the tree-structure, according to the filtering unit.

44. The method of claim 23, wherein the extracting comprises extracting the information about in-loop filtering from a Sequence Parameter Set (SPS) or a Picture Parameter Set (PPS) of the picture.

45. The method of claim 23, wherein:
the coding units according to the tree-structure which are comprised in the maximum coding unit are hierarchical according to the depths in one region in the maximum coding unit and are independent according to the coded depth in other regions; and
the coding units are determined to independently output encoding results according to a coded depth for deeper coding units that are hierarchically structured according to depths indicating a number of times the coding units are spatially split from the maximum coding unit.

46. The method of claim 23, further comprising performing prediction decoding on a next picture by referring to the current picture to which the in-loop filtering is performed.

47. A video encoding apparatus for encoding a video by performing in-loop filtering based on coding units, the video encoding apparatus comprising:
an encoding unit determining unit which splits a picture into a maximum coding unit that is a data unit, wherein the maximum coding unit has a maximum size, separately determines coding units to output encoding results according to a coded depth for deeper coding units that are hierarchically structured according to depths indicating a number of times the coding units are spatially split from the maximum coding unit, the coding units determined according to a tree-structure, wherein the coding units are hierarchical according to the depths in one region in the maximum coding unit and are independent according to the coded depth in other regions;
an in-loop filtering unit which determines a filtering unit to perform in-loop filtering so as to minimize an error between the maximum coding unit and an original picture, based on the coding units according to the tree-structure of the maximum coding unit, and performs the in-loop filtering based on the filtering unit; and
a transmitting unit which encodes information about the in-loop filtering and transmits the encoded information about the in-loop filtering, encoded data of the picture, and encoded mode information about the coding units according to the tree-structure of the maximum coding unit in units of filtering units.

48. A video decoding apparatus for decoding a video by performing in-loop filtering based on coding units, the video decoding apparatus comprising:
a receiving and extracting unit which parses a received bitstream and extracts image data encoded for each of coding units based on the coding units according to a tree-structure which are comprised in a maximum coding unit obtained by splitting a current picture, extracting encoded mode information about the coding units according to the tree-structure, and extracting information about in-loop filtering of the maximum coding unit;
a decoding unit which decodes the extracted image data, based on the extracted encoded mode information which is extracted for the maximum coding unit; and
an in-loop filtering performing unit which determines, using the information about in-loop filtering, a filtering unit for the in-loop filtering based on the coding units according to the tree-structure of the maximum coding unit, and performs the in-loop filtering on the decoded image data of the maximum coding unit according to the filtering unit.

49. A computer readable recording medium having recorded thereon a program for executing the method of encoding of claim 1.

50. A computer readable recording medium having recorded thereon a program for executing the method of decoding of claim 23.
